(19) United States
(12) Patent Application Publication
(10) Pub. No.: US 2026/0358920 A1
(43) Pub. Date: Nov. 12, 2026

(54) ADAPTIVE CALIBRATION OF HAPTIC TOUCHPADS

(71) Applicant: Microsoft Technology Licensing, LLC, Redmond, WA (US)

(72) Inventors: Lior ZAGIEL, Tel Aviv (IL); Roei Shlomo MENASHOF, Netanya (IL); Oren ISTRIN, Tel Aviv (IL)

(21) Appl. No.: 19/202,716

(22) Filed: May 8, 2025

(51) Int. Cl. G06F 3/041; G06F 3/01; G06N 3/02

(52) U.S. Cl. CPC G06F 3/0418; G06F 3/016; G06F 3/041; G06F 3/0414; G06N 3/02; G06F 2203/04105

(57) ABSTRACT

Adaptive calibration of force sensors in haptic touchpads compensates performance degradation in real-time to maintain like-new performance. Calibration can be sensor-specific, user-specific, and force-specific (e.g., due to non-linear sensors). Force sensors are calibrated based on reference data (e.g., baseline force data for known forces) and touch event data. Calibration is determined by combining (e.g., calculating a weighted average of) compensation parameters determined by multiple compensation algorithms, such as Recursive Least Squares (RLS), Kalman Filter, a neural network (NN), and/or an Exponential Moving Average (EMA). Calibrated sensor data is monitored for accuracy relative to reference data.

### BACKGROUND

Computing devices often utilize touch input devices, such as touchscreens and touchpads, which are touch-sensitive surfaces that allow users to control the computing devices using their fingers. For example, a touchscreen display on a phone, tablet, or notebook computer allows a user to interact with displayed content by touching a display screen or pad. A touchpad is often utilized in portable computers as an integrated mouse but can also be used to provide additional forms of input. A touchpad can have integrated buttons a user can press or click and/or that can be configured to recognize selections based on gestures, such as tapping a finger on the touchpad once to perform a “select” and tap twice to perform an “open” (which mimics the pressing or double-clicking of a button). Other recognized gestures for touchscreens and touchpads include, for example, sliding or dragging a finger to move a cursor, pinching two fingers to zoom in, separating two fingers to zoom out, swiping to scroll, to switch between applications, etc.

Touchpads include mechanical touchpads and haptic touchpads. A mechanical touchpad has one or more buttons a user can click (e.g., by hand or by instrument) while a haptic touchpad mimics a click (e.g., by hand or by instrument). Touchpads often include a microcontroller (e.g., a system on a chip (SoC) configured to process touch input data received by touch sensors. The microcontroller reports the touch inputs to the operating system or application, which generates feedback. For example, the OS or application can generate displayable content showing user input, such as cursor movements, selections, drawings, etc., while the user interacts with displayed content using a touchpad.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Adaptive calibration of haptic touchpads is disclosed herein. Such adaptive calibration compensates for touch device degradation over time to maintain like-new (e.g., newly manufactured; straight from factory) touch device performance. Calibration is performed during ongoing touch device detection, classification, and response to user touch events, and is adaptable or customizable to each user and/or each force sensor, given that users apply different forces in different areas of a touchpad and that force sensor responses can be nonlinear relative to applied force. Signals generated by each force sensor in response to touch events are calibrated based on device reference data (e.g., baseline force data for response to known forces by a new device) and user-specific force data for touch events. Compensation parameters are used individually or fused together (e.g., by calculating a weighted average of) that are determined by one or more compensation algorithms, such as Recursive Least Squares (RLS), Kalman Filter, a neural network (NN), and/or an Exponential Moving Average (EMA).

In an aspect, a computing device comprises a touch device (e.g., a haptic touchpad) and a calibrator (calibration manager) configured to calibrate the haptic touchpad in real time in response to hardware degradation. The computing device includes a touch sensor configured to detect contact (e.g., touch events) on the touch device and one or more force sensors configured to detect force applied during touch events. The computing device further includes a data collector configured to collect force sensor data (e.g., indicating applied force) generated by a force sensor in the haptic touchpad for touch events on the haptic touchpad. The collector collects reference data for the force sensor using known forces (e.g., during an initial calibration when the computing device is new). The computing device can also include a tracker that monitors which user is using the device and/or a trigger to initiate calibration for each user (e.g., based on accumulated force sensor data for the user). The computing device can also include a calibration preprocessor configured to filter and normalize the sensor data before compensation. A compensator of the computing device is configured to determine compensation for one or more force sensors based on the force sensor data and the reference data. The compensator can include one or more of an RLS compensator, a Kalman filter compensator, a neural network compensator, an EMA compensator, etc. The computing device may also include a determiner configured to determine a calibration for the force sensor based on the compensation. For example, multiple compensation parameters can be merged into a final calibration based on a weighted average of the compensation parameters. Still further, the computing device may include an adapter configured to apply the calibration to the force sensor. The computing device monitors the performance of calibrated force sensors and can make corresponding corrections.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example computing device with a haptic touchpad implementing adaptive calibration, in accordance with an embodiment.

FIG. 2 shows a cross-sectional view of an example haptic touchpad illustrating one or more components of a force sensor array that can degrade over time, in accordance with an embodiment.

FIG. 3 shows a block diagram of a touch manager with a calibration manager for adaptive calibration of a haptic touchpad, in accordance with an example embodiment.

FIG. 4 shows a block diagram of a calibration manager for providing adaptive calibration of a haptic touchpad, in accordance with an example embodiment.

FIG. 5 shows a flowchart for an example process for providing adaptive calibration of a haptic touchpad, in accordance with an embodiment.

FIG. 6 shows a flowchart for an example process for providing adaptive calibration of a haptic touchpad, in accordance with an embodiment.

FIG. 7 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Computing devices often utilize touch input devices, such as touchscreens and touchpads, which are touch-sensitive surfaces that allow users to control the computing devices using their fingers. For example, a touchscreen display on a phone, tablet, or notebook computer allows a user to interact with displayed content by touching a display screen or pad. A touchpad is often utilized in portable computers as an integrated mouse but can also be used to provide additional forms of input. A touchpad can have integrated buttons a user can press or click and/or that can be configured to recognize selections based on gestures, such as tapping a finger on the touchpad once to perform a “select” and tap twice to perform an “open” (which mimics the pressing or double-clicking of a button). Other recognized gestures for touchscreens and touchpads include, for example, sliding or dragging a finger to move a cursor, pinching two fingers to zoom in, separating two fingers to zoom out, swiping to scroll, to switch between applications, etc.

Touchpads include mechanical touchpads and haptic touchpads. A mechanical touchpad has one or more buttons a user can click by pressing down upon the touchpad (e.g., by hand or by instrument), whereby the press upon the touchpad causes mechanical motion in the touchpad that is registered as the click (e.g., by activating a physical switch). In contrast, a haptic touchpad mimics a click (e.g., by hand or by instrument). When the user presses on the haptic touchpad, the haptic touchpad does not physically move and thus does not register the click by mechanical motion. Instead, the haptic touchpad detects the click intent by the user by a force sensor (e.g., a touch sensor) without the haptic touchpad moving, and may respond with feedback to the user (e.g., a click sound, a vibration) to let the user know the intended click was registered as a click. Touchpads often include a microcontroller (e.g., a system on a chip (SoC)) configured to process touch input data received by touch sensors. The microcontroller reports the touch inputs to the operating system or application, which generates feedback. For example, the OS or application can generate displayable content showing user input, such as cursor movements, selections, drawings, etc., while the user interacts with displayed content using a touchpad.

Haptic touchpads include components that may degrade over time. Degradation may occur due to sensor wear based on usage, environmental variations (e.g., heat, humidity), and/or natural aging effects (e.g., material characteristics changing with age). Degradation may alter performance from the calibration of the device relative to the known “fresh” or “new” state (e.g., established at the factory). Degradation may lead to calibration drift (e.g., deviation from design performance parameters). Calibration drift results in inaccuracies during operation because the conversion between sensor readings and actual applied force leads to variations from the “factory-calibrated” state.

Touch sensor inaccuracy may lead to inaccurate classification and interpretation of touch events. Inaccurate determinations of user input lead to erratic device behavior and user frustration, which may be due to user interruption and delay to re-enter user input and/or to correct errant operations based on misinterpretations of user input. Furthermore, inaccurate determinations can lead to excess consumption of energy (e.g., battery depletion) involved in inaccurate reporting, processing, and undo operations related to inaccurate determinations of user input. Repairs, loss of use, and/or replacement of computing devices with touch sensor issues may be costly.

The novel technology described herein overcomes these and further deficiencies of the art. In particular, adaptive calibration of haptic touchpads is disclosed herein. Such adaptive calibration compensates for touch device degradation over time to maintain like-new touch device performance. This adaptive calibration can be performed during ongoing touch device detection, classification, and response to user touch events. Furthermore, such calibration can be adapted or customized to each user and/or each force sensor, e.g., given that users apply different forces in different areas of a touchpad and force sensor responses can be nonlinear relative to applied force. The signals generated by each force sensor in response to touch events are calibrated based on device reference data (e.g., baseline force data for response to known forces by a new device) and user-specific force data for touch events. Touch device calibration can be determined by fusing together (e.g., calculating a weighted average of) compensation parameters determined by multiple compensation algorithms, such as Recursive Least Squares (RLS), Kalman Filter, a neural network (NN), and/or an Exponential Moving Average (EMA). RLS can be used to estimate a compensation parameter to map normalized applied force to reference force signals. A Kalman filter can be used to estimate a compensation parameter in a noisy environment. A neural network can be used to estimate a compensation parameter based on a model of a nonlinear force sensor having a nonlinear relationship between applied force and signal output by the force sensor. EMA can be used to estimate a compensation parameter that smooths out short term fluctuations while following long term trends of sensor responses.

In an aspect, a computing device comprises a touch device (e.g., haptic touchpad) and a calibrator (calibration manager) configured to calibrate the haptic touchpad (e.g., in real time in response to hardware degradation). The computing device includes one or more of a touch sensor, one or more force sensors, a data collector, a tracker, a trigger, a calibration preprocessor, a compensator, a determiner, and/or an adaptor. The touch sensor is configured to detect contact (e.g., touch events) on the touch device. The force sensors are configured to detect force applied during touch events. For instance, in one configuration, to measure applied force, a force sensor assesses a distance between a top and a bottom of a touchpad. Each time a user applies force to the touchpad, a force sensor mechanism, such as a spring, compresses, which alters this distance and corresponds to the measured force applied. Over time, the mechanism degrades (e.g., a stiffness of the spring may change), resulting in different measured distances for the same applied force. The data collector is configured to collect this force sensor data (e.g., distances indicating applied force) generated by a force sensor in the haptic touchpad for touch events on the haptic touchpad.

Furthermore, the collector collects reference data for the force sensor using known forces (e.g., during an initial calibration when the computing device is new). The reference data includes “ground truth” reference force measurements for each of the force sensors, which may include force measurements made when no force is applied to the force sensors (via no contact with the touchpad) and may include force measurements made when enough force is applied to the force sensors (via contact with the touchpad) to fully actuate the force sensors, such that the distance difference between these two measurements may be considered a baseline/reference “ground truth” force sensor actuation distance (e.g., ground truth distance “x”). By gathering the reference data before the touchpad has degraded, the touchpad force sensing can be calibrated due to any degradation that happens thereafter (e.g., after manufacture in the factory), thereby enhancing the user experience. As noted above, degradation of a mechanism of the force sensors may result in a change in force measurements (e.g., measure distance) for a given amount of applied force. For instance, under the assumption the user applies the same amount of force each time the user clicks the touchpad, and it is determined that the measured distance changes during a subsequent user click of the touchpad relative to the reference measured distance (ground truth =distance “x”, new measurement =distance “y”), it is implied that something in the force sensor mechanism has changed due to degradation, such as a degradation in a spring.

The tracker is configured to monitor which user is using the device. The trigger is configured to initiate calibration for each user (e.g., based on accumulated force sensor data for the user). The calibration preprocessor is configured to filter and normalize the sensor data before compensation. In this manner, noise and/or outlying force measurements may be removed from the sensor data, thereby resulting in more accurate force sensor calibrations. The compensator is configured to determine compensation for one or more force sensors based on the force sensor data and the reference data. The compensator can include one or more of an RLS compensator, a Kalman filter compensator, a neural network compensator, an EMA compensator, etc.

For instance, continuing the above example, when the measured distance changes during a subsequent user click of the touchpad relative to the reference measured distance (ground truth=distance “x”, new measurement=distance “y”), the compensator may be configured to modify an internal calculation made by the determiner to fit the new measurement. For instance, instead of a user click measured distance “x” corresponding to a force measurement of 150 grams, the compensator may alter (due to the degradation) the internal calculation performed by the determiner such that a user click measured distance “y” now corresponds to the force measurement of 150 grams. Furthermore, in an embodiment, because in real situations, user click force is not constant, instead of a single number, a force equation used by the determiner may be modified. For instance, a value of coefficients “a”, “b” may be changed by the compensator in a force equation such as shown as Equation 1 below:

Force=a*Distance+B Equation 1

The determiner is configured to determine a calibration for the force sensor based on the compensation. For example, multiple compensation parameters can be merged into a final calibration based on a weighted average of the compensation parameters. The adapter is configured to apply the calibration to the force sensor. The computing device can monitor the performance of calibrated force sensors and make corrections.

Advantages or benefits of the embodiments described further herein include maintaining user satisfaction with a computing device, maintaining touch device accuracy, extending the life of a computing device, reducing production and consumption of computing devices, avoiding costly downtime and delays associated with repairs, avoiding introduction of contaminants and/or potential damages during repair and/or replacement, avoiding inconsistency of manual recalibration, etc. Maintaining accurate sensor performance can help algorithms perform correctly, avoid sending erroneous reports from the digitizer to the OS, avoid unnecessary processing of erroneous reports, avoid erroneous responses, and subsequent undo operations, thereby conserving energy (e.g., battery life for portable devices).

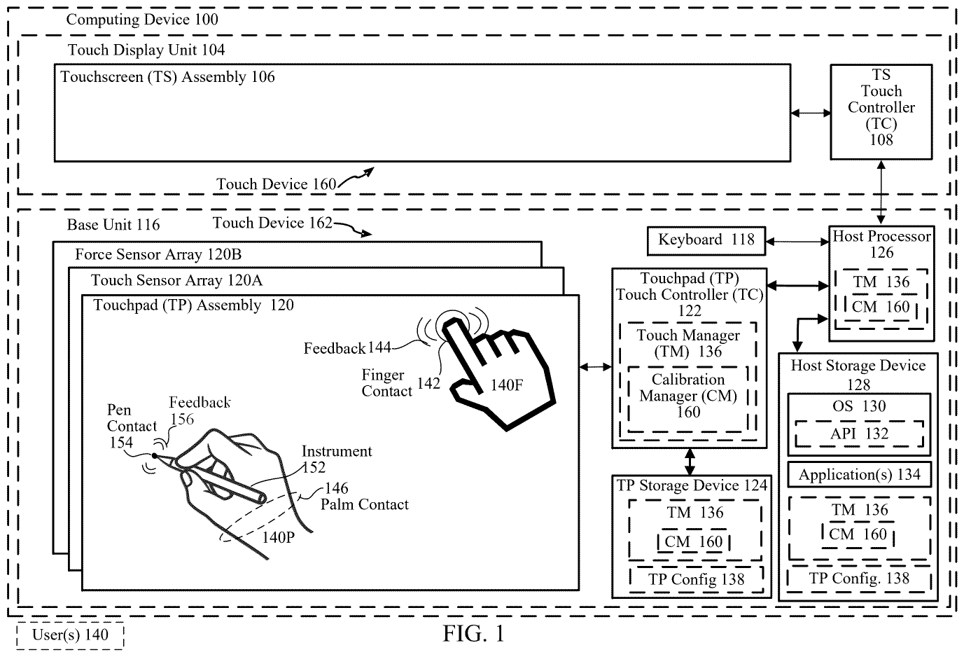

Embodiments disclosed herein can be configured in various ways. For instance, FIG. 1 shows a block diagram of an example computing device 100 with a capacitive touch interface implementing adaptive calibration of a haptic touchpad, in accordance with an embodiment. As shown in FIG. 1, computing device 100 includes a touch display unit 104 and a base unit 116. Touch display unit 104 includes a touch device 160, which includes a touchscreen (TS) assembly 106 and a touch controller (TC) 108. TS assembly 106 includes a touch sensor array and a display panel (not shown). Base unit 116 includes a keyboard 118, a touch device 162, a touchpad (TP) touch controller (TC) 122, a TP storage device 124, a host processor 126, and a host storage device 128. Touch device 162 includes a touchpad (e.g., a haptic touchpad) formed at least of a touchpad (TP) assembly 120 that includes a touch sensor array 120A and a force sensor array 120B. TP TC 122 includes a touch manager 136 that includes a calibration manager (CM) 160. TP storage device 124 stores a touch manager 136 and a touchpad configuration (TP config) 138. Touch manager 136 includes a CM 160. Host processor 126 includes a touch manager 136, which includes a CM 160. Host storage device 128 stores an operating system 130 (that includes an application programming interface (API) 132), one or more applications 134, a touch manager 136 (that includes a CM 160), and a touchpad configuration 138. The components of computing device 100 are described in further detail as follows.

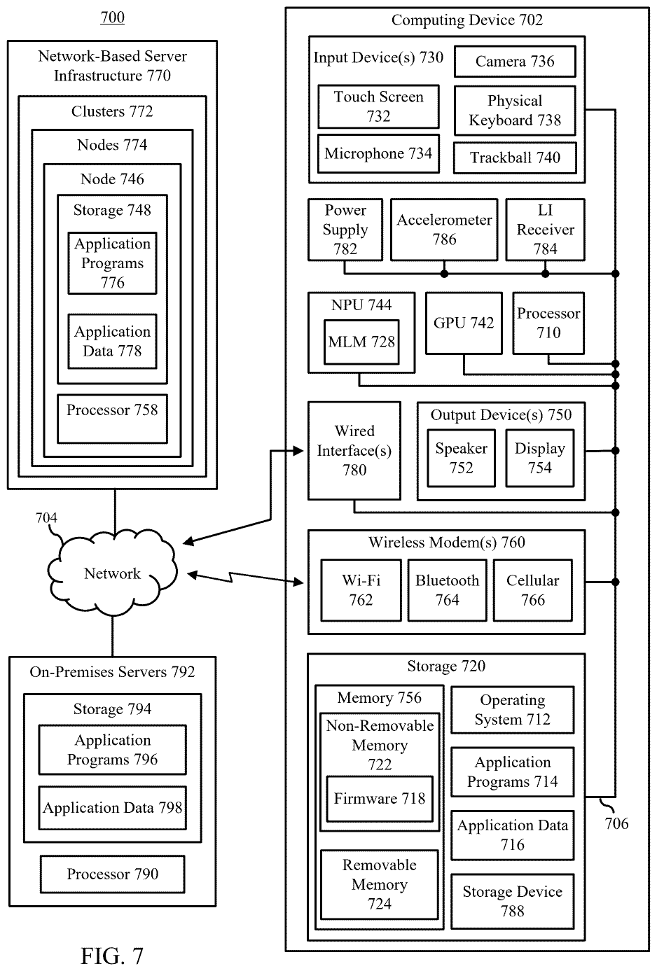

Computing device 100 may be any type of stationary or mobile computing device with a touch input device, including a mobile computer or mobile computing device (e.g., a 2-in-1 device, a personal digital assistant (PDA), a laptop computer, a notebook computer, a tablet computer, a netbook, etc.), a mobile phone, a wearable computing device, or other type of mobile device, or a stationary computing device such as a desktop computer or PC (personal computer), or a server, with at least one touch input device. Example computing device 100 presents one of many possible examples of computing devices. Another example computing device with example features is presented in FIG. 7.

As shown in FIG. 1, computing device 100 (e.g., as shown) may comprise a repositionable notebook computer, a laptop computer, a 2-in-1 computer, a tablet with a case/cover (e.g., with a wired or wireless input device in the case/cover), etc. Computing device 100 includes a touch display unit 104 and a base unit 116. For example, touch display unit 104 (e.g., in an upper/lid portion of computing device 100) and base unit 116 may be physically connected (e.g., by a rotating connector or hinge, a separable connector) and may implement wired communication, or may be physically separate and implement wireless communication (e.g., by a Bluetooth connection). Other computing devices may have the same, similar, or different configuration of touch input devices, with or without other input devices. These components of computing device 100 are described in further detail as follows.

As described herein, a touch device can be any type of touch device, e.g., touchscreen, touchpad, etc. “Touch” is synonymous with “contact,” regardless of what makes contact with (e.g., touches) a touch device. For example, contact can be made with a touch device (e.g., the touch device can be touched) by a user's finger, a user's palm, moisture, an active instrument (e.g., pen), a passive instrument, etc. Each contact event (e.g., touch event) can include one or more locations of touch/contact. Each location of contact/touch can be referred to as a contact point or touchpoint. For example, in a single touch event a user can simultaneously touch multiple touchpoints, e.g., by simultaneously touching a touch device with two fingers to make a gesture to zoom in or zoom out or by simultaneously touching the touch device with a pen and the user's palm.

Touch display unit 104 includes a touchscreen assembly 106 and a touchscreen (TS) touch controller (TC) 108. Touch display unit 104 may include one or more user input and output devices, such as touchscreen assembly 106. Other examples of computing devices may have the same, similar, and/or other types and configurations of input devices, such as a peripheral touchscreen.

Touchscreen assembly 106 provides a touch input device (e.g., touch sensitive digitizer) and an output device (e.g., a display), among other hardware, firmware and/or software components. The touch digitizer (“digitizer”) comprises capacitive touch sensor element grids or arrays. A touch sensor array of TS assembly 106 may occupy any area (including all) of touchscreen assembly 106 even though not illustrated as such in FIG. 1. Touchscreen assembly 106 includes touch sensor array and display panel.

In some examples (e.g., as shown in FIG. 1), touchscreen assembly 106 may comprise, from bottom to top, a display panel, a touchscreen sensor array, and a cover glass that user 140 touches, e.g., with layers of transparent adhesive between the display panel, touchscreen sensor array, and cover glass. The touchscreen sensor array and cover glass may be substantially transparent, or with wires, electrodes, and sensor sufficiently small so as to be unnoticeable to most human vision.

The display panel may be, for example, a liquid crystal display (LCD) or a light emitting diode (LED) display. The display panel may be driven, for example, by a graphics processing unit (GPU) (not shown). User 140 interacts with content displayed by the display panel, for example, by touching touchscreen assembly 106, which is detected by the touch sensor array. Further examples of display and GPU are discussed in FIG. 7.

The touchscreen touch digitizer (e.g., touch sensor array) may comprise, for example, a capacitive type of touch digitizer, e.g., projected capacitance (mutual or self), in-cell, on-cell, out-cell, etc. The touchscreen touch digitizer may be configured to detect touch, for example, via capacitive coupling with an instrument (not shown), a finger, a palm, moisture, etc. in close proximity to touchscreen assembly 106 that results in capacitance at one or more locations of the touch sensor array. The detection pitch or resolution of the touch sensor array may be, for example, fractional to multiple mm.

Touch sensors in the touch sensor array detect locations where touch events occur (e.g., where a user finger, instrument, palm, moisture touch touchscreen assembly 106). Capacitive touchscreens work similarly to capacitive touchpads. Touch sensor(s) utilizing capacitive technology maintain an electrical charge across the touch sensor array. A touch disrupts the charge in the area touched. Locations of contact may be indicated by x, y coordinates on the touch sensor array, which may be mapped to the display panel. Capacitance values across an area of the touch sensor array indicate the size and shape of contact in each (e.g., 10 msec) frame. Comparing capacitance values across frames can indicate change in size, shape, and movement of contact/touch. Depending on the application 134 or OS 130 that user 140 is interacting with, the user's finger movement across the touch sensor array can be translated on the display panel into a selection, a resizing, a drawing, a cursor movement, etc.

Touchscreen (TS) Touch controller (TC) 108 controls at least the touch digitizer of touchscreen assembly 106 (e.g., touch sensor array). TS TC 108 is a microcontroller, which is a computer on a chip (e.g., an integrated circuit), including one or more processors, memory, and programmable inputs/outputs (I/O) configured to implement, e.g., among other functions, the touch interface. TS TC 108 may be configured to process touch sensor data, e.g., periodically. For example, TS TC 108 may be configured to process touch sensor data every x us or msec (e.g., 100 times per second or 10 msec) to provide a touchscreen interface for user 140.

TS TC 108 may be configured to receive and process touch signals detected by a touch sensor array. TS TC 108 may process touch data, e.g., based on a touchscreen configuration (not shown). TS TC 108 may send processed touch signal reports to host processor 126, e.g., for processing relative to OS 130 and/or one or more applications 134 that user 140 may be interacting with via touchscreen assembly 106, e.g., by passive pen contact or finger contact.

TS TC 108 may control modes of operation of touchscreen assembly 106. Touchscreen assembly 106 may have a plurality of touch detection modes, e.g., touch or passive mode, active or pen mode, which may be implemented, at least in part, by TC 108. TC 108 may (e.g., in a touch or passive instrument mode), for example, drive a signal on at least one antenna (e.g. X or Y, row or column, vertical or horizontal portion of a grid) in the touch digitizer portion of touchscreen assembly 106, which may project an electric field over touchscreen assembly 106, and monitor the other antenna/electrode for changes (e.g. caused by a conductive pattern in proximity to touchscreen assembly 106). Signal changes may result in detected signals, each with an associated position and intensity/magnitude. TS TC 108 may (e.g., in an active instrument mode), for example, not drive a signal on an antenna and may (e.g. instead) monitor for (e.g. capacitively coupled) active signals in the touch digitizer portion of touchscreen assembly 106, where each detected signal may have an associated position and intensity/magnitude.

Touchscreen assembly 106 and TS TC 108 may generate positive and negative binary large objects (BLOBs) representative of the area, size, and location of detected touches, which may be accompanied by additional information associated with the BLOB s. The determination of touch inputs may be configured, e.g., by a user, and/or dynamically adapted (e.g., by TS TC 108 and/or host processor 126). For example, touchscreen assembly 106 and TS TC 108 may detect contact based on one or more (e.g., adaptable and/or configurable) sensitivity (e.g., signal intensity) thresholds. In some examples, TS TC 108 may be configured to report touches (e.g., BLOBs) and associated data to OS 130, e.g., executed by host processor 126. In some examples, TS TC 108 may be configured to process touch data to confirm that touch data represents a touch before reporting confirmed touches to OS 130.

Base unit 116 may include one or more integrated and/or peripheral user input devices, such as keyboard 118 and touchpad assembly 120. Other examples of computing devices may have the same, similar, and/or other types and configurations of input devices, such as a peripheral touchpad. Note that touchpad and trackpad are used interchangeably herein.

Keyboard 118 is an input device that user 140 can use to provide input to computing device 100. In some examples, one or more keys may be programmed to customize operation of TM 136 and/or CM 160 (e.g., for a particular application or user) for touchpad assembly 120.

Touchpad assembly 120 includes a touchpad touch digitizer (“digitizer”) (e.g., touch sensor element grids or arrays) among other hardware, firmware, and/or software components. Touchpad assembly 120 provides a touch input device (e.g., touch sensitive digitizer shown as touch sensor array 120A and force sensor array 120B) and haptic feedback via one or more haptic actuators (not shown). Touchpad assembly 120 is an input device that user 140 can use to provide a variety of inputs to computing device 100, such as controlling a cursor, making selections, drawing, zooming in or out, etc. An example touchpad in a notebook computer (e.g., touchpad assembly 120) may be, for example, approximately 90 mm×150 mm (3-½ inches×6 inches). In some examples (e.g., as shown in FIG. 1), touchpad assembly 120 may comprise, from bottom to top, one or more haptic actuators (a vibration mechanism), force sensor array 120B, touch sensor array 120A and a cover material that user 140 touches. The one or more haptic actuators provide feedback to users, such as a simulation (e.g., a sound) of a mechanical button press or mouse click when user 140 taps TP assembly 120 with a finger or instrument.

The touchpad touch digitizer (e.g., touch sensor array 120A and force sensor array 120B) may comprise any type of touch digitizer, e.g., projected capacitance (mutual or self), in-cell, on-cell, out-cell, etc. The touchpad touch digitizer (e.g., touch sensor array 120A and force sensor 120B) may be configured to detect touch, for example, via capacitive coupling with an instrument, a finger, a palm, moisture, etc. in close proximity to touchpad assembly 120 that results in capacitance at one or more locations of touch sensor array 120A and/or force sensor array 120B. The detection pitch or resolution of touch sensor array 120A may be, for example, fractional to multiple mm.

Touch sensors in touch sensor array 120A detect locations (e.g., touchpoints) where user 140 touches touchpad assembly 120. Capacitive touch sensor array 120A may work similarly to the capacitive touch sensor array of TS assembly 106. Touch sensor(s) utilizing capacitive technology may maintain an electrical charge across touch sensor array 120A. A touch disrupts the charge in the area touched. Locations of connections may be indicated by x, y coordinates on the touch sensor array 120A, which may be mapped (e.g., with a starting location of the x, y location of user's finger or instrument on TP assembly 120) to the display panel in TS assembly 106 to provide visual feedback of user operations. Capacitance values across an area of touch sensor array 120A will indicate the size and shape of contact in each (e.g., 10 msec) frame. Comparing capacitance values across frames can indicate change in size, shape, and movement of contact/touch. Depending on the application 134 or OS 130 that user 140 is interacting with, the user's finger movement across the touch sensor array 120A can be translated on a display panel of touch display unit 104 into a selection, a resizing, a drawing, a cursor movement, etc.

Force sensor array 120B includes one or more force sensors (e.g., pressure sensors). For example, force sensor array 120B may include six force sensors. Force sensors detect the force applied by user 140 (e.g., by finger, palm, instrument) during a touch event. In some examples, force sensor array 120B can be integrated with touch sensor array 120A. Thus, in various implementations, force sensors can be integrated with touch sensors or may comprise discrete pressure sensors. Different levels of force applied by a user are reflected (e.g., measured) in the differences between signals (e.g., signal magnitudes) generated by pressure sensor(s). The relationship between applied force and force sensor signal can be linear or nonlinear (e.g., exponential). In some examples, force sensors may comprise opposing conductive materials (e.g., pads) separated by a compressive material, where application of force to TP assembly 120 compresses the compressive material, thereby changing the distance between the plates, which results in detectable signals indicating the applied pressure. Force sensor array 120B may be calibrated, for example, when computing device 100 is new. An initial calibration may record baseline signal responses for known forces at precise locations, which may be utilized or referenced during subsequent calibrations of force sensor array 120B. For example, force sensors in force sensor array 120B can identify reference sensor signals in response to application of 100 grams, 120 grams, 140 grams, 160 grams, 180 grams, etc. applied at precise coordinates on touchpad assembly 120. A user's applied force during touch events can be interpreted in view of the set of reference measurements and for purposes of calibrating the force sensor signals over time.

The performance of force sensor array 120B may change over time. One or more components of force sensor array 120B may vary over time. Force example, the compressive characteristics of a compressive material in force sensor array 120B may change over time based on use, environment (e.g., exposure to heat, humid or dry air), material degradation (e.g., decomposition), etc. Degradation may occur nonlinearly over force sensor array 120B, for example, because user 140 interacts with one part of TP assembly 120 more than other parts of TP assembly 120. Accordingly, each sensor may be calibrated independently of other sensors. In this manner, one or more force sensors in the force sensor array may be individually calibrated so that force sensor array 120B is regionally calibrated across its two-dimensional area such that touch sensitivity and responsiveness are improved across the entirety of TP assembly 120, thereby improving the user experience. The signals generated by each sensor may be compensated differently from signals generated by other force sensors in accordance with detected degradation of sensor operation. Further, signal compensation for each sensor may vary by applied force, for example, in view of a nonlinear relationship between applied force and force sensor signal. Further still, sensor calibration may vary by user of computing device 100. Accordingly, touchpad calibration may include complex sensor-specific, force-specific, and/or user-specific calibration operations. Despite the complexities, calibration may maintain factory/new performance of TP assembly 120. Calibration of force sensor array 120B, or TP assembly 120 as a whole, may be managed by calibration manager (CM) 160.

Touchpad (TP) touch controller (TC) 122 (e.g., a programmed processor executing all or part of touch manager (TM) 136 and calibration manager (CM) 160) controls at least the touch digitizer of touchpad assembly 120. TP TC 122 is a microcontroller, which is a computer on a chip (e.g., an integrated circuit), including one or more processors, memory, and programmable inputs/outputs (I/O) configured to implement, e.g., among other functions, touch-sensing touchpad interface, e.g., by executing all or part of TM 136 and CM 160. TP TC 122 may be configured to process touch sensor data and force sensor data, e.g., periodically. For example, TP TC 122 may be configured to process touch sensor data and force sensor data every x us or msec (e.g., 100 times per second or 10 msec) to provide a touchpad interface for user 140.

TP TC 122 may be configured to receive and process touch signals generated by touch sensors in touch sensor array 120A and force signals generated by force sensors in force sensor array 120B. The number of touch sensors in touch sensor array 120A may be (e.g., significantly) different from the number of force sensors in force sensor array 120B. TP TC 122 may process touch data and force data based on TM 136, which may be configured by touchpad configuration 138. CM 160 (e.g., executed by TP TC 122 and/or host processor 126) may be configured to maintain force sensor data over time via application of force sensor calibration (e.g., which may apply compensation to signals generated by force sensors). TP TC 122 may execute all or a portion of TM 136 and CM 160. TP TC 122 may send processed touch event signal reports to host processor 126, e.g., for processing relative to OS 130 and/or one or more applications that user 140 may be interacting with via touchpad assembly 120, e.g., by pen contact 154 or finger contact 142. Reports may include touch sensor data and force sensor data.

TP TC 122 may control modes of operation of touchpad assembly 120. Touchpad assembly 120 may have a plurality of touch detection modes, e.g., touch or passive mode, active or pen mode, which may be implemented, at least in part, by TP TC 122. TP TC 122 may (e.g., in a touch or passive instrument mode), for example, drive a signal on at least one antenna (e.g. X or Y, row or column, vertical or horizontal portion of a grid) in the touch digitizer portion of touchpad assembly 120 (e.g., touch sensor array 120A and force sensor array 120B), which may project an electric field over touchpad assembly 120, and monitor the other antenna/electrode for changes (e.g. caused by a conductive pattern in proximity to touchpad assembly 120). Signal changes may result in detected signals, each with an associated position and intensity/magnitude. TP TC 120 may (e.g., in an active instrument mode), for example, not drive a signal on an antenna and may (e.g. instead) monitor for (e.g. capacitively coupled) active signals in the touch digitizer portion of touchscreen assembly 120 (e.g., touch sensor array 120A and force sensor array 120B). Each signal may have an associated position and intensity/magnitude for a set of touch sensors in touch sensor array 120A and a set of force sensors in force sensor array 120B. A “set” may include zero or more sensors.

Touchpad assembly 120 and TP TC 122 may generate positive and negative BLOBs representative of the area, size, and location of detected touches, which may be accompanied by additional data (e.g., applied force data) associated with the BLOBs. The determination of touch inputs (e.g., and associated data) may be configured, e.g., by a user, and/or dynamically adapted (e.g., by TM 136 executed by TP TC 122 and/or host processor 126). For example, touchpad assembly 120 and TP TC 122 may detect touch or force based on one or more (e.g., adaptable and/or configurable) sensitivity (e.g., signal intensity) thresholds (e.g., stored in touchpad configuration 138). In some examples, TP TC 122 may be configured to report touches (e.g., BLOBs) with associated data (e.g., force data) to OS 130, e.g., executed by host processor 126. In some examples, TP TC 122 may be configured to process touch data and force data to confirm that touch data represents a touch before reporting confirmed touches to OS 130.

TP storage device 124 may store touch manager (TM), CM 160, and touchpad configuration 138 used by TM 136. TP TC 122 may load and execute executable instructions in TM 136 and CM 160, as may be configured by touchpad configuration 138. TP storage device 124 may comprise any of one or more types of memory, e.g., non-removable memory, removable memory, random access memory (RAM), read only memory (ROM), flash memory, a solid-state drive (SSD), a hard disk drive (e.g., a disk drive for reading from and writing to a hard disk), and/or other physical memory device types.

TM 136 (e.g., executed by TS TC 108) can be configured to control sampling of the touch sensor array 120A and force sensor array 120B. TM 136 controls processing of the samples to classify any contact (e.g., touch events) in the samples according to classes in a set of classifications, such as finger, palm, instrument, moisture, etc. TM 136 implements touch profiling and classification (e.g., machine learning (ML) classification) of touch events, for example, by extracting and processing (e.g., analyzing) contact/touch features (e.g., characteristics, parameters), such as contact shape, area, capacitive intensity, contact dynamics (e.g., change in size, change in shape, movement over multiple frames), temporal characteristics, palm indication, spatial clustering, applied force, etc., which may be combined with adaptive/customized profiling and/or adaptive/customized classification (e.g., adaptive thresholds).

CM 160 (e.g., executed by TS TC 108) is configured to implement adaptive calibration of force sensor array 120B in haptic touchpad assembly 120. Calibration compensates for the degradation of force sensor array 120B over time. Calibration may seek to maintain like-new touch device performance for force sensor array 120B. Calibration can occur, for example, in the background during ongoing touch device detection, classification, and response to user touch events, or during a time when user 140 is not interacting with computing device 100. CM 160 can be configured to perform calibration based on satisfaction of one or more triggers, such as accumulation of a data for a threshold number of touch events to be analyzed. By waiting to accumulate sufficient data, CM 160 operates more efficiently by performing recalibration periodically rather than continually, thereby conserving processor cycles. CM 160 can implement calibration of sensors in force sensor array 120B for each of multiple users. By calibrating based on a user-by-user basis, the experience for each user of multiple users is improved. CM 160 can implement calibration for each force sensor in force sensor array 120A because degradation may occur unevenly. For example, user(s) 140 may interact with an area of a touchpad assembly 120 more than another area, leading to more degradation in one area than another. CM 160 can implement calibration dependent on applied force, e.g., because force sensor responses can be nonlinear relative to applied force.

Each sensor response to touch events (e.g., signals providing force sensor data) can be calibrated based on device reference data (e.g., baseline force data for response to known forces by a new device) and user-specific force data for touch events. CM 160 may be configured to (e.g., continuously) learn each user's force when clicking (e.g., during a touch event). A user reference force is the force applied to one or more sensors when the device is first used without significant hardware drift. A user reference force can be used as a “ground truth” to recalibrate the touchpad throughout its lifespan. One or more compensation parameters can be determined for use in determining sensor calibration. For example, calibration can be determined by fusing together (e.g., calculating a weighted average of) compensation parameters determined by multiple compensation algorithms, such as Recursive Least Squares (RLS), Kalman Filter, a neural network (NN), and/or an Exponential Moving Average (EMA). RLS can be used to estimate a compensation parameter to map normalized applied force to reference force signals. A Kalman filter can be used to estimate a compensation parameter in a noisy environment. A neural network can be used to estimate a compensation parameter based on a model of a nonlinear force sensor with a nonlinear relationship between applied force and signal output by the force sensor. The neural network has the advantage of being easily trainable (according to techniques disclosed herein) based on historical applied forces and signal outputs as compared to a specific, complex algorithm being implemented, which may have high processor cycle requirements. EMA can be used to estimate a compensation parameter that smooths out short term fluctuations while following long term trends of sensor responses. Dynamic adjustment of force sensor calibration parameters automatically compensates for deviations caused by hardware degradation, which may preserve optimal performance and accuracy.

TM 136 and/or CM 160 can perform data collection of touch event data, which includes force sensor data (e.g., indicating applied force) generated by one or more force sensors in force sensor array 120B. TM 136 and/or CM 160 can collect reference data for each force sensor using known forces, for example, during an initial calibration when the computing device 100 is new. Reference data may be referred to as, for example, a learned user force, a baseline force, a ground truth, etc. TM 136 and/or CM 160 can include a tracker that monitors which user is using the device, e.g., to perform calibration for each user. The calibration trigger may have the same or different triggers to initiate calibration for each user (e.g., based on accumulated force sensor data for the user and/or elapsed time since a previous calibration, and so on). CM 160 can include a calibration preprocessor configured to filter and normalize force sensor data before one or more compensators generate a compensation parameter for each sensor. CM 160 can include a compensator configured to determine compensation for one or more force sensors based on the force sensor data and the reference data. The compensator can include, for example, one or more of an RLS compensator (which is capable of rapidly updating calibration parameters in response to hardware drift), a Kalman filter compensator (which is capable of refining adjustments despite measurement noise), a neural network compensator (which is trainable, and thus less complex than implementing an algorithm, and captures any nonlinearities), an EMA compensator (which is capable of smoothing short-term fluctuations), etc.

CM 160 can include a determiner configured to determine a calibration for the force sensor based on the one or more compensation parameters, e.g., in view of current and past calibrations of each force sensor. For example, multiple compensation parameters can be merged into a final calibration based on a weighted average of the compensation parameters. TM 136 and/or CM 160 can include an adapter configured to apply the calibration to the output signal generated by force sensor. As previously indicated, the calibration may vary per sensor, per applied force, and/or per user. CM 160 can include a monitor to monitor the performance of calibrated force sensors. CM 160 can include a corrector configured to make corrections and/or reset to a previous calibration, e.g., upon detection of one or more anomalies.

Thus, as TP assembly 120 ages and as force sensor array 120B incurs varying degrees of sensor-specific hardware drift, CM 160 can automatically adjust calibration for each force sensor to align the output of each sensor in force sensor array 120A with baseline force signals of the force sensors when computing device and/or TP assembly 120 was/were new. Automated calibration eliminates the need for manual recalibration and maintains the accuracy of TP assembly 120, even after extensive use.

Host processor 126 may execute executable instructions in OS 130, application(s) 134, TM 136, and/or CM 160. Further examples of host processor 126 and host storage device 128 are shown in FIG. 7.

Host storage device 128 may store an operating system (OS) 130, which may include application programming interface (API) 132, application(s) 134, touch manager (TM) 136, CM 160, and/or touchpad configuration 138 used by TM 136. Host storage device 128 may comprise any of one or more types of memory, e.g., non-removable memory, removable memory, random access memory (RAM), read only memory (ROM), flash memory, a solid-state drive (SSD), a hard disk drive (e.g., a disk drive for reading from and writing to a hard disk), and/or other physical memory device types.

Host processor 126 loads and executes OS 130, which provides overall operation of computing device 100. OS 130 may provide a user interface for user 140 to configure operation of TM 136 and/or CM 160 (e.g., configure touchpad configuration 138) to process touch events detected by TP assembly 120 and/or to calibrate force sensor array 120B for one or more users. For example, a default calibration trigger may be overridden by user 140, such as user initiated calibration. Additional discussion of OS 130 is provided in discussion of FIG. 7 (e.g., OS 712). Processor 126 may load and execute A PI 132, which can be configured to support dynamically adapted and/or customized operation of touch-sensing touch detection and processing implemented by application(s) 134 and/or TM 136.

Processor 126 loads and executes application(s) 134, for example, in response to user selection of application(s) 134. Application(s) 134 may include, for example, a word processing program, a spreadsheet program, a game, etc., that user 140 can interact with through TS assembly 106 and/or TP assembly 120. Application(s) 134 may provide a user interface for user 140 to configure operation of TM 136 and/or CM 160 (e.g., configure touchpad configuration 138) to apply to touch inputs detected by TP assembly 120.

Processor 126 may load and execute some, none, or all of TM 136 and/or CM 160, for example, during boot up of computing device 100. TM 136 is configured to provide a touch interface in concert with TP assembly 120 and CM 160 is configured to provide calibration of force sensor array 120B in TP assembly 120. In various examples, TM 136 and/or CM 160 may be implemented in hardware, hardware combined with one or both of software and/or firmware, and/or as program instructions encoded on computer-readable storage media, configured to perform functions and/or operations described herein for a touch interface in association with user interaction with touchpad assembly 120. TM 136 and/or CM 160 may provide a user interface for user 140 to configure operation of TM 136 and/or CM 160 (e.g., configure touchpad configuration 138) to apply to touch inputs detected by TP assembly 120.

In various examples, application(s) 134, operating system (OS) 130, virtual machines (VMs) (not shown), etc., may be executed, hosted, and/or stored on computing device 100 or via one or more other computing devices via network(s) (e.g., not shown). Computing device 100 (e.g., via TS TC 108, TP TC 122, and/or host processor 126) executes one or more processes. A process is any type of executable (e.g., binary, program, application) that is being executed by computing device 100 (e.g., via TS TC 108, TP TC 122, host processor 126, and/or the like).

As shown in FIG. 1, user 140 interacts with integrated and/or peripheral input and output devices associated with computing device 100. In various examples, the interactive input devices include one or more touch-sensing touch devices, such as TS assembly 106 and TP assembly 120. User interactions include, for example, touching touchscreen assembly 106, typing on keyboard 118, and touching touchpad assembly 120. User 140 can provide input, for example, by hand (e.g., touch 142) and/or by input device (e.g., instrument/stylus/pen 152). User input may be reflected in updates to imagery displayed by the display panel of TS assembly 106.

A user 140, whose hand is represented as 140F when used to make finger contact 142 and as 140P when holding instrument 152 used to make pen contact 154 (e.g., with or without making palm contact 146), uses touchscreen assembly 106 and touchpad assembly 120 for input in response to imagery shown by the display panel in the touchscreen assembly 106 portion of touch display unit 104. As shown on TP assembly 120, finger contact 142 and pen contact 154 result in detection of contact/touch events by touch sensor array 120A and force sensor array 120B. The touch events may occur over one or more frames. For example, touch device 160 and/or touch device 162 may generate 100 frames per second (e.g., one frame every 10 msec). Thus, even a relatively fast contact will generate contact information over multiple frames, which results in a detectability of change in size, shape, and/or movement of contact over multiple frames. For example, a contact by a finger or pen may be detected to increase in size and then decrease in size as the user approaches, makes contact, and withdraws a finger or pen from touch device 160 or touch device 162. Also shown on TP assembly 120, as the user 140 makes passive pen contact 142 as an intentional touch the user 140 may also make an unintentional palm touch 146, which may be detected as one or more touchpoints. For example, the palm touch may be detected as one or more touches similar to finger touches rather than as a single large touch more indicative of a palm. The user can also make unintended palm touches on the TP assembly 120, for example, while typing on keyboard 118. A user may also provide instrument input (e.g., pen touch) using an active touch instrument.

The touch interface implemented by TP assembly 120 and TM 136 are configured to accurately identify finger touch 142 and passive pen touch 154 as user input and to reject palm touch 146 and moisture touch (not shown) as non-user input/unintentional input by evaluating the detected touches based on touch profiles indicated by features extracted from touch event datasets generated by touch sensor array 120A and force sensor 120B, combined with data generated by a data collector in TM 136 based on touch sensor data and force sensor data. The touch interfaces (e.g., by operation of TM 136) collect/extract a set of data features from the datasets and classify a detected touch as a user input class (e.g., finger contact/touch 142, passive instrument contact/touch 154) or non-user input class (e.g., palm touch 146, moisture touch), for example, based on whether the touch profile indicated by the set of touch features) falls within the touch profile of a finger touch, active instrument (e.g., pen) touch, passive instrument touch, palm touch, moisture touch or other defined touch classification. Contact/touch features (e.g., characteristics, parameters) may include, for example, contact shape, area, capacitive intensity, contact dynamics (e.g., change in size, change in shape, movement over multiple frames), temporal characteristics, palm indication, spatial clustering, OS and/or application context, applied force, etc., which may be combined with adaptive/customized profiling and/or adaptive/customized classification (e.g., adaptive thresholds). Calibration performed by CM 160 maintains applied force data despite degradation of touchpad assembly 120 in support of touch event classification by TM 136.

As shown in FIG. 1, passive pen contact feedback 156 and/or finger contact feedback 144 may be provided by haptic feedback associated with TP assembly 120 at locations (e.g., touchpoints) where a confirmed touch event (e.g., touch input) occurred or at another location with reference to a touch event. Feedback may also be visual, for example, on touch display unit 104. For example, a visual effect may be displayed by display panel in TS assembly 106 at the mapped location of finger touch 142 and/or passive pen touch 154.

TM 136 and CM 160 can be centralized or distributed. Executable versions of TM 136 and CM 160 are shown in dashed lines, e.g., stored in a storage device such as TP storage device 124 and/or host storage device 128, and executed in TS TC 108, TP TC 122, and/or host processor 126. The dashed lines indicate that operations performed by TM 136 and CM 160 can be centralized or distributed. For example, powerful microcontrollers TS TC 108 and TP TC 122 may be configured to perform most or all operations of TM 136 and CM 160 while less capable microcontrollers TS TC 108 and TP TC 122 may perform little to no operations of TM 136 and CM 160. Instead, host processor 126 may be configured to perform most or all operations of TM 136 and CM 160.

Operations of TM 136 and CM 160 can include obtaining, determining, and managing touchpad configuration 138, which is also shown (e.g., by dashed lines) to be centralized or distributed for storage and utilization in TP storage device 124 and/or host storage device 128.

The touch interface (e.g., via TM 136) can be configured to dynamically adjust/adapt/calibrate touch profiles (e.g., features), touch feature weights, touch determination sensitivity (e.g., threshold(s)), compensation/calibration parameters of force sensors of TP assembly 120 based on, for example, detected/processed finger, palm, instrument, and/or moisture touches, screen and/or ambient environmental conditions (e.g., humidity or moisture detection), detected performance degradation, etc. The dynamic adjustments may be stored, for example, in the prevailing touchpad configuration 138 applied by TM 136 and/or CM 160 to data in touch event datasets (e.g., including force datasets).

TM 136 (e.g., executed by TS TC 108, TP TC 122, and/or host processor 126) can be configured to control sampling (e.g., data generation and collection) of TP touch sensor array 120A and force sensor array 120B. TM 136 can be configured to control processing of the samples to classify any touch events in the samples according to classes in a set of classifications, such as finger, palm, passive instrument, active instrument, moisture, and/or other classes. TM 136 may be configured to apply force sensor calibrations to force sensor data determined by CM 160. TM 136 implements touch profiling and classification (e.g., machine learning (ML) classification) of touch events, for example, by analyzing touch characteristics, such as contact shape, area, capacitive intensity, contact dynamics (e.g., change in size, change in shape, movement over multiple frames), temporal characteristics (e.g., touch time, touch consistency), palm indication, spatial clustering, OS and/or application context, applied force, etc. TM 136 (e.g., including CM 160) may be configured to implement adaptive and/or user-customized touch profiling (e.g., set of features/characteristics that characterize each touch type), feature weights, and/or touch classification (e.g., adaptive classification thresholds), force sensor data calibrations, etc. For example, TM 136 and/or CM 160 can be configured to provide one or more user interfaces for feedback, customization, and/or calibration. TM 136 may be configured to provide notification/feedback to users (e.g., visual and/or haptic feedback), operating system 130, and/or application(s) 134 to respond to detection (e.g., classification) of classified user input (e.g., passive pen contact 154, finger contact 142) and/or other input (e.g., unintentional input).

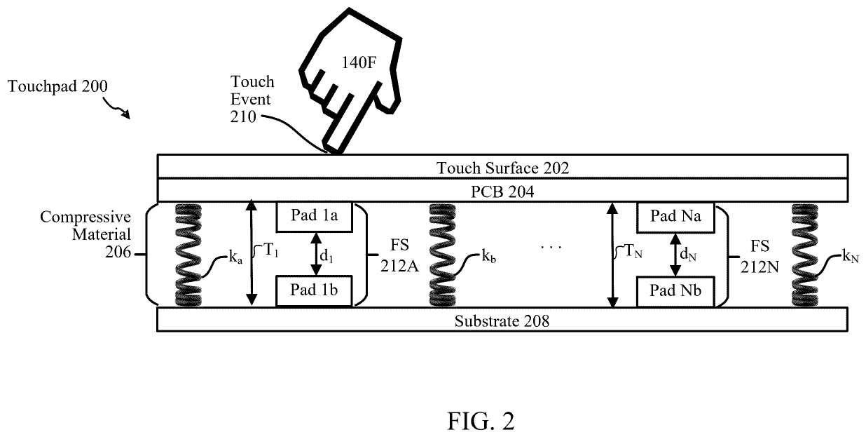

FIG. 2 shows a cross-sectional view of an example haptic touchpad 200 illustrating one or more components of a force sensor array that can degrade over time, but can be compensated for by sensor calibration, in accordance with an embodiment. As shown in FIG. 2, touchpad 200 includes a touch surface 202, a printed circuit board (PCB) 204, a compressive material 206, and a substrate 208 formed in a stack (from top layer to bottom layer). Any suitable adhesive material (e.g., an epoxy) may be used to bind the layers of touchpad 200 shown in FIG. 2, as would be known to persons skilled in the relevant art(s). These layers of touchpad 200 are described in further detail as follows.

Touch surface 202 comprises the top layer of touchpad 200 that user 140 interacts with by hand and/or by instrument. Printed circuit board (PCB) 204 comprises circuitry forming all or part of touch sensor array and force sensor array of haptic touchpad 200. PCB 204 includes a first set of force sensor pads or electrodes, e.g., pad 1a to pad Na, where N represents the number of force sensor pads. In some examples, there may be six force sensor pads (e.g., N=6). The first set of force sensor pads pad la to pad Na can be configured to be aligned with a second set of pads pad 1b to pad Nb on substrate 208. The first and second sets of pads can be manufactured using conductive material (e.g., a metal or metal alloy). The first and second sets of pads can be separated by compressive material 206. Aligned first and second pads separated by a distance d by compressive material 206 may form a capacitor. PCB 204 may include circuitry that applies a voltage to the first set of pads 1a-Na to create an electric field between each set of aligned pads.

Compressive material 206 separates PCB 204 and substrate 208 as well as first set of pads 1a-Na and second set of pads 1b-Nb. Compressive material 206 may be an insulative material (e.g., a dielectric material such as a plastic or polymer). Compressive material 206 is configured to compress in response to application of force on touch surface 202. Compressive material 206 is shown to be flexible based on a springiness illustrated by springs that may not be physically present in compressive material 206. The thickness T of compressive material 206, the resting distance d between aligned first and second pads (e.g., d₁ to d_{N}), and/or the springiness or compressibility characteristic k of compressive material 206 (e.g., enumerated by compressibility factors or parameters kₐ to K_{N}) may vary across compressive material 206 initially (e.g., as a result of manufacture) and/or over time (e.g., based on degradation caused by use, environmental exposure, etc.). For example, one or more users may interact with one part of touchpad 200 more than another part of touchpad 200, leading to differences in localized variations of thickness T, compressibility characteristic k, zero force (e.g., resting) distance d between pads, and/or range of distance between pads in response to application of different forces, which can nonlinearly vary already nonlinear signals generated by force sensors in response to touch events.

Substrate 208 comprises a material on which the second set of pads are configured, which one side of compressive material 206 is affixed to, and/or on which touchpad 200 as a whole is affixed to.

Each pair of aligned pads separated by compressive material 206 (e.g., along with accompanying circuitry on PCB 204) creates a capacitive force sensor (FS) or pressure sensor. Touchpad 200 is shown with force sensors FS 212A through FS 212N, although any number of force sensors 212 may be present.

As shown in FIG. 2, user 140 causes a touch event 210, using a finger, by contacting touch surface 202 at a touchpoint (e.g., coordinate identified location on touch surface 202). Compressive material 206 compresses based on the force applied at the touchpoint during the touch event 210. The touchpoint could be anywhere on touch surface 202, e.g., directly over a force sensor, between force sensors, etc. Force sensor circuitry on PCB 204 may apply a voltage to the first set of pads la-Na to create an electric field between the first and second sets of pads for each force sensor FS 212A though FS 212N. A change in the distance between the opposing set of pads creates a signal indicative of the applied force. The first force sensor FS 212A generates a force signal indicative of applied force, for example, when the distance d1 between first and second pads 1a and 1b changes in response to application of force during touch event 210. Multiple force sensors can generate signals, for example, when a user applies force at a touchpoint between force sensors.

As described herein, the signals generated by each force sensor FS 212A-FS 212N in response to various applications of force during touch events can change over time. CM 160 is configured to calibrate each force sensor, as needed, by compensating signals generated by each force sensor. The objective of calibration (e.g., by independent compensation of signals generated by each force sensor) can be to maintain like-new performance of force sensors in touchpad 200.

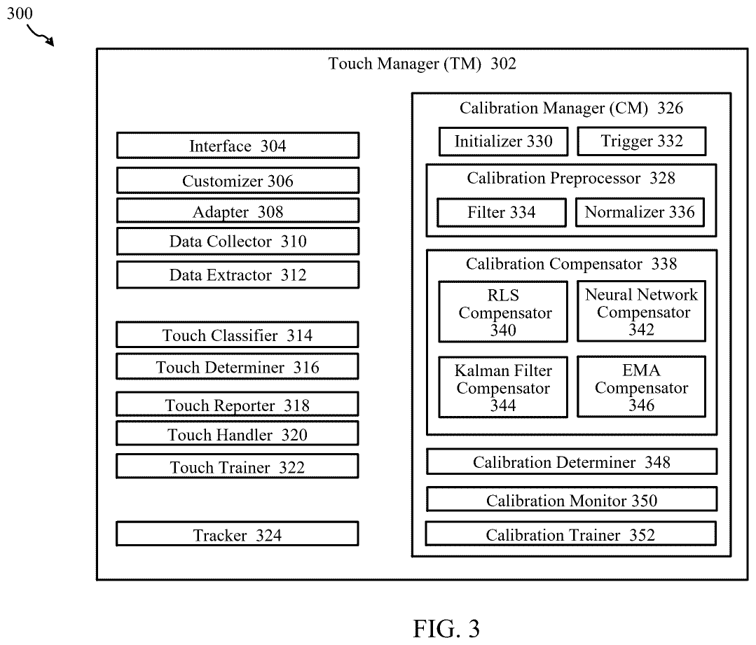

Calibration manager 160 of FIG. 1 may be configured in various ways. For instance, FIG. 3 shows a block diagram of an example of a haptic touchpad 300 with an example of a touch manager (TM) 302 and an example of a calibration manager (CM) 326 for adaptive calibration of the haptic touchpad, in accordance with an embodiment. TM 302 is an example of TM 136 shown in FIG. 1 and CM 326 is an example of CM 160 in FIG. 1. TM 302 and CM 326 may be implemented in hardware or hardware combined with firmware and/or software, which may be executed with respect to a touchpad, for example, by TP TC 122 and/or host processor 136. TM 302 (e.g., with CM 326) shows one of many possible examples of operational components for adaptive calibration of force sensors in a haptic touchpad. As shown in FIG. 3, TM 302 includes interface 304, customizer 306, adapter 308, data collector 310, data extractor 312, touch classifier 314, touch determiner 316, touch reporter 318, touch handler 320, touch trainer 322, tracker 324, and CM 326. CM 326 includes an initializer 330, a trigger 332, a calibration preprocessor 328, a calibration compensator 328, a calibration determiner 348, a calibration monitor 350, and a calibration trainer 352. Calibration preprocessor 328 includes a filter 334 and a normalizer 336. Calibration compensator 338 includes a Recursive Least Squares (RLS) compensator 340, a Kalman Filter compensator 344, a neural network compensator 342, and an Exponential Moving Average (EMA) compensator 346. Other examples may implement the same or different operational components. The components of TM 302 are described in further detail as follows.

Interface 304 may be configured to access/receive input and access/provide output for operations of TM 302. Interface 304 may include one or more different types of interfaces, which may be wired or wireless. For example, interface 304 may read information from and write information to one or more storage devices, such as TP storage device 124 and/or host storage device 128. Interface 304 may provide (e.g., send/transmit) reports (e.g., classified or unclassified touch event BLOBs) generated by touch reporter 318 to OS 130. Interface 304 may receive and store (e.g., buffer) touch data (e.g., including applied force data) obtained by data collector 310. Interface 304 may provide touch data (e.g., including applied force data) to data extractor 312, e.g., and write extracted data/feature sets to storage device(s) for analyses by TM 302 and CM 326. Interface 304 may access and provide touch data/features to touch classifier 314 and NN compensator 342 generated by data extractor 312 or labeled data/features on behalf of touch trainer 322 and calibration trainer 352. Interface 304 may access and provide classified touches to touch handler 320 for analysis/determination of and response to user intent, e.g., relative to content (e.g., provided by OS 130 and/or application(s) 134) displayed by the display that user 140 appears to have interacted with by the interpreted touch event(s) and/or handling of non-user input, such as providing feedback for detected user input touch events. Interface 304 may provide one or more user interfaces, e.g., for user 140 to directly or indirectly customize touch/contact profiles, weights, classification thresholds, calibration compensators, weight for weighted averaging by calibration determiner 348, calibration triggers, etc. In some examples, interface 304 provides a graphical user interface (GUI) that allows manual calibration by users (e.g., user 140). Interface 304 may display the calibration status to users.

Customizer 306 may be configured to allow user 140 to customize (e.g., directly or indirectly) touch profiles, feature weights, classification thresholds, calibration compensators, weights for weighted averaging by calibration determiner 348, calibration triggers, etc. User 140 may be motivated to provide user settings/customization to adjust configuration/operation of a touch profiles and/or classifications (e.g., improve differentiation of touch inputs and non-touch inputs), for example, based on accessibility, such as to overcome limitations in hand and/or finger usage, based on application-specific reasons, such as gaming or word processing, and/or based on environment-specific reasons, such as working in a hot, humid environment or a cold, dry environment. User 140 may be motivated to provide user settings/customization to adjust (e.g., select) calibration compensators, weights for weighted averaging by calibration determiner 348, calibration triggers, etc., for example, to calibrate the performance of the touchpad on demand and customize the calibration procedure.

Customizer 306 can improve user accessibility and application-specific interaction (e.g., gaming) by supporting customization of touch to more accurately identify user inputs for one or more touch devices (e.g., touchscreen, touchpad). Customizer 306 may be configured to allow user 140 to navigate a user interface (e.g., part of interface 304) and select/specify/configure user settings for touch-based user input detection for touchscreen assembly 106 and/or touchpad assembly 120. Customizer 306 may provide a user interface or may utilize an interface provided by interface 304. For example, customizer 306 may permit user 140 to provide user settings via direct input and/or via training that can change one or more profiling/classification characteristics, such as the touch size, shape, duration, consistency, capacitance intensity, dynamics (e.g., shape change, size change, movement pattern), clustering, palm indication, applied force, and/or other parameter(s) utilized by classifier(s) to detect user input, distinguish between different types of user input, and/or distinguish between user input and non-user input. Customizer 306 may recognize one or more keys (e.g., key combinations) programmed to customize operation of TM 302 (e.g., for a particular application or user) for touch inputs detected by a touchscreen and/or touchpad.

Customizer 306 may store customized settings, for example, in touchpad configuration 138. In some examples, customizer 306 may be combined with adapter 308, e.g., providing dynamic adaptation algorithms and a customization user interface to (e.g., directly or indirectly) customize touch profiles, feature weights, classification thresholds, calibration compensators, weights for weighted averaging by calibration determiner 348, calibration triggers, etc.

Adapter 308 may be configured to adapt or adjust (e.g., implement changes to) the calibration of force sensors in the force sensor array in accordance with calibration determiner 348 and calibration monitor 350. Adapter 308 may be configured to implement any customizations or other adaptations for CM 326, such as customizations of calibration compensators, weights for weighted averaging by calibration determiner 348, calibration triggers, etc.

Adapter 308 may (e.g., also) be configured to adapt one or more parameters used by touch classifier 314 to distinguish between user input classes and/or non-user input classes. Adapter 308 may be configured to dynamically adjust one or more parameters, for example, to improve accuracy in differentiation and classification of different types of touch inputs and non-touch inputs. Adapter 308 may adjust profiling/classification parameters/characteristics, weights, and/or thresholds for the parameters/characteristics of classes. Parameters/characteristics may include, for example, touch size, shape, duration, consistency, capacitance intensity, dynamics (e.g., shape change, size change, movement pattern), clustering, palm indication, applied force, and/or other classification/differentiation parameter(s), such as difference (delta) thresholds between user input (e.g., finger touch, instrument touch, such as passive pen or active pen) and non-user input (e.g., palm touch or moisture touch). Adjuster 208 may adjust parameters based on, for example, processing of detected touch inputs (e.g., differentiations between finger, palm, instrument, moisture touches), detected ambient environment (e.g., humidity, temperature), detected screen environment (e.g., moisture detection, temperature), etc.

Adapter 308 may store force sensor calibration parameters and touch sensor operation parameters (e.g., thresholds), for example, in touchpad configuration 138 for use by CM 326 and touch classifier 314.

Data collector 310 may be configured to collect a dataset that includes one or more touch events, e.g., including force sensor data used for calibration and/or training of machine-learning models, such as NN 342. Data collector 310 may include one or more touch samplers to collect data from different touch devices (e.g., touch device 160, touch device 162) and/or from different sensor arrays (e.g., touch sensor array 120A, force sensor array 120B). Data collector 310 may perform sampling of touch sensor array 120A, force sensor array 120B, and/or other sources of data pertinent to touch profiling/classification and calibration. Data collector 310 receives sampled data from touch sensor array 120A and force sensor array 120B. Data collector 310 may be scheduled to sample (e.g., periodic sampling) or may sample ad hoc (e.g., on demand). For example, data collector 310 may perform sampling periodically (e.g., every 10 msec) or based on detection of a change in capacitance on touch sensor array 120A and/or force sensor array 120B. Touch sensor data may generate a “heat map.”

In some examples, data collector 310 and data extractor 312 may be merged (e.g., data collector 310 may be a data collector-generator performing data extraction). For example, data collector 310 may perform data generation (e.g., data/feature extraction/calculation), for example, by processing collected data to generate other data. In some examples, data collector 310 may include a signal processor/analyzer to analyze collected data. Data collector 310 may be configured to collect and/or generate a list of data/features indicated in a configuration (e.g., TP configuration 138) for touch type classification, force sensor calibration, etc.

Data collector 310 may store each of a series of periodically collected and/or generated datasets in TP storage device 124 and/or host storage device 128. Data collector 310 may track contacts/touches through multiple frames. For example, data collector 310 may assign identifiers (IDs) to each contact/touch to track each touch event through multiple frames. Breaking contact and re-establishing contact may result in assignment of a different ID to re-established contact. Touch event tracking allows data extractor 312 to extract data/features determined across multiple frames for each contact/touch. For example, the applied force detected through sensor signal data may vary across multiple frames. The force sensor signals may vary nonlinearly across multiple frames. CM 326 can use stored touch event data to determine nonlinear compensation to be applied to force sensor signals during a single touch spanning across multiple frames. Data collector 310 may collect and store data by user, for example, based on an indication of the current user by tracker 324. As previously indicated, force sensor calibration may be configured to be user-specific.

Data extractor 312 may be configured to extract a set of data/features from the dataset collected by data collector 310. Data extractor 312 may process each dataset collected by data collector 310. In some examples, data extractor 312 may perform data filtering and normalization (e.g., filter 334, normalizer 336). For example, data extractor 312 may perform noise reduction by filtering out electrical noise in a dataset and normalize data for use, e.g., by touch classifier 314 and calibration compensator 338. Data extractor 312 may also be referred to as a featurizer. Data extractor 312 may be configured to preprocess extracted data using a data preprocessor (e.g., data filter, data transformer, data normalizer), such as calibration preprocessor 328, to transform and/or normalize data. Data extractor 312 may be configured to extract a set of data/features utilized by touch classifier 314 to classify touch events and calibration compensator 338 to generate one or more compensation values. For example, data extractor 312 may be configured to extract one or more of the following features for each frame for each touch event in a dataset: touch/contact location, size (e.g., area), shape, temporal (e.g., touch duration, consistency), capacitance intensity, dynamics (e.g., shape change, size change, movement pattern), clustering, palm indication, applied force, standard deviation of applied force, etc. Data extractor 312 may extract, for example, a BLOB representing a touch event and associate additional data (e.g., force sensor data) with the BLOB so that touch classifier 314 can classify the BLOB and associated data and CM 326 can perform calibration on force sensors. The associated data may include or may reference multiple frames that show touch duration, consistency, movement, shape change, size change, applied force, etc., which may be useful for classification/differentiation among classes. Data extractor 312 may perform calculations or otherwise determine (e.g., extract) features, such as geometric profile and size, contact dynamics (e.g., shape change, size change, movement patterns), touch duration and consistency, spatial distribution of touchpoints, changes in applied force across frames, etc.

Data generator 312 may be configured to generate a list of data/features indicated in a configuration (e.g., TP configuration 138) for touch type classification, force sensor calibration, etc. Static and dynamic data/features in the set of data/features allows touch classifier 314 and CM 326 to identify complex relationships and subtle shape nuances that go beyond simple area or density metrics, which results in more robust classification and force sensor calibration.

Touch classifier 314 (e.g., with touch determiner 316) provides real-time inferences/classification of contacts on one or more touch devices. Touch classifier 314 may be configured to classify each touch event based on the set of data/features (e.g., dataset) extracted by data extractor 312 for each frame of each touch event. Touch classifier 314 may include one or more contact/touch event classifiers. A machine-learning (ML) model (e.g., an ML model executed by host processor 126, an NPU, and/or TP TC 122) may perform classification. In some examples, classifier(s) may generate classifications associated with probabilities (e.g., confidence levels). The classifications may function as intermediate classifications, which may be further analyzed in view of the probabilities and classification thresholds. Thresholds can be fixed, variable, adaptable, and/or customizable. In some examples, touch classifier 314 may classify touch events as a class among the following set of classes: finger touch, palm touch, passive instrument/pen touch, active pen touch, moisture touch, moisture cluster (e.g., for multiple touch inputs/events), and/or palm cluster (e.g., for multiple touch inputs/events).

Touch classifier 314 may be implemented in firmware and/or software. Touch classifier 314 may be an adaptive algorithm or an heuristic algorithm. For example, touch classifier 314 may include trained machine-learning (ML) model(s) and/or heuristic classifiers. ML model touch classifier 314 may be trained by touch trainer 322 to classify feature sets indicating touch profiles for one or more touch events. An M L model is trained to recognize patterns and differences between different classes or types of contact, such as finger contact 142 and passive pen contact 156. Further description of the training and implementation of M L models applicable to ML model 164 (FIG. 1) and other M L models referenced herein is provided with respect to ML model 728 of FIG. 7.

Touch determiner 316 may be configured to analyze classifications generated by touch classifier 314, e.g., based on associated probabilities compared to one or more classification thresholds. For example, a default classification/confidence threshold may be 90% or 0.9. Touch determiner 316 could be configured to finally classify a contact classified as a user touch input with a 90% probability as user touch, which may be reported to the OS for handling. Touch determiner 316 could be configured to delay a decision for a contact classified as a user touch input with an 89% probability over multiple frames to confirm or reject the classification. The threshold may be fixed or variable, e.g., based on environmental conditions. For example, adapter 308, e.g., if not disabled, may adjust the threshold based on detected environmental conditions. User 140 may customize the classification threshold(s) with fixed or variable thresholds, e.g., with indications of conditions to change customized threshold values.

Touch reporter 318 may be configured to report information from the touch device to the host or from the host to the host, e.g., OS 130, application(s) 134, or host processor 126. Touch reporter 318 may be configured to report pre-classification information and/or post-classification information. In some examples, touch reporter 318 may be configured to report touch BLOBs and associated data (e.g., pre-classification information) to OS 130 for classification (e.g., by touch classifier 314 if/when executed by host processor 126). In some examples, touch reporter 318 may be configured to report touch BLOBs confirmed by touch classifier 314 to be user input, which may avoid erroneous reports on non-user input and, thereby, conserve energy. In some examples, touch reporter 318 may be configured to report classifications by touch determiner 316 to OS 130 for handling (e.g., by touch handler 320).

Touch handler 320 may be configured to handle or process (e.g., interpret and respond to) the meaning of classified touch inputs. Touch handler 320 may be implemented, for example, by OS 130 and/or application(s) 134. Touch handler 320 may interpret the meaning (e.g., user intent) of user input based on the context of the OS 130 or application(s) 134 in which the user input was provided. The context may be based on the information displayed by the display panel of touch display unit 104 at the location of user input (e.g., finger contact 142, passive pen contact 154). For example, a user input may be determined to be a selection in a displayed menu or movement of a pointer. Touch handler 320 effectuates the determined intent of the user input. In some examples, a classified user input (e.g., via finger or passive pen) may not occur in the vicinity of an interactive user interface, which may result in no action being taken.

Touch handler 320 may be configured to provide feedback for user input (e.g., finger touch 142, pen touch 154) and/or non-user input (e.g., palm touch 146, moisture touch). Feedback includes, for example, updating the information displayed on the display to reflect the most recent user touch event(s). Touch handler 320 may be configured to provide feedback at locations where user input was confirmed based on classification by touch classifier 314 and confirmation by touch determiner 316. For example (e.g., as shown in FIG. 1), feedback 144 or feedback 156 may be provided at locations where touch input was confirmed by touch classifier 314 and touch determiner 316 to be, respectively, user input by finger touch 142 or by pen touch 154. Feedback may be visual, haptic, etc. For example, haptic feedback may be provided by a haptic actuator associated with TP assembly 120 and/or a visual effect may be displayed by display panel associated with TS assembly 106 at the mapped input location of finger touch 142 and pen touch 154 to let the user know that the user input was detected. Touch handler 320 may handle (e.g., respond to) touch classifications for OS 130.

Touch trainer 322 may be configured to train touch classifier 314 to classify contact/touch event data/feature sets. Touch trainer 322 may be configured to train touch classifier 314 using training data comprising labeled feature sets, e.g., labeled with the correct classification(s). A training process may split a dataset into training and validation sets, e.g., to train the classifier model on the training set and validate performance of the trained classifier model on the validation set. The labeled dataset may be created based on empirical examples collected during actual or simulated use of computing device 100 or a similar computing device in a variety of environments. Touch trainer 322 may implement supervised learning to train an M L model classifier 214, such as neural networks, support vector machines (SVM), or decision trees. Touch trainer 322 may perform hyperparameter tuning, e.g., to optimize a classifier model's hyperparameters to improve accuracy and generalization.

Tracker 324 is configured to monitor the current user of the computing device. Tracker 324 may identify an active user, for example, based on an indication by the operating system (e.g., OS 130). Tracking users allows data segregation/labeling and user-specific calibrations based on the segregated/labeled data. Tracker 324 can be configured to provide notification of the current user to TM 302 and CM 326. TM 302 and CM 326 can store and access data associated with the current user, load a touchpad configuration 138 associated with the user, and perform operations, such as touch classification and force sensor calibration based on the current user's current data, historical data, and configuration.

CM 326 (e.g., executed by TP TC 122) is configured to implement adaptive calibration of force sensors (e.g., in force sensor array 120B in haptic touchpad assembly 120). Calibration compensates for the degradation of force sensors over time. Calibration may seek to maintain like-new touch device performance for force sensors. Calibration can occur, for example, in the background during ongoing touch device detection, classification, and response to user touch events, or during a time when a user (e.g., user 140) is not interacting with touchpad 300. CM 326 can implement calibration of sensors in force sensor array 120B for each of multiple users. CM 326 can implement calibration for each force sensor in force sensor array 120B because degradation may occur unevenly. For example, user(s) 140 may interact with an area of a touchpad assembly 120 more than another area, leading to more degradation in one area than another. CM 326 can implement calibration dependent on applied force, e.g., because force sensor responses can be nonlinear relative to applied force. CM 326 can automatically adjust calibration for each force sensor to correct hardware drift by aligning the output of each sensor in force sensor array 120A with baseline force signals of the force sensors when computing device and/or TP assembly 120 was/were new. Automated calibration by CM 326 eliminates the need for manual recalibration and maintains the accuracy of TP assembly 120, even after extensive use.

As shown in FIG. 3, CM 326 may be implemented as part of TM 302. In other examples, CM 326 may be implemented independent of TM 302. In the example shown in FIG. 3, TM 302 and CM 326 can be configured to share operation by one or more modules, such as interface 304, customizer 306, adapter 308, data collector 310, data extractor 312, tracker 324, etc. In the example shown in FIG. 3, CM 326 calibrates forces sensors in a force sensor array of touchpad 300. In some examples, CM 326 can be configured to calibrate additional components of touchpad 300. CM 326 comprises calibration preprocessor 328, calibration compensator 338, calibration determiner 348, calibration monitor 350, and calibration trainer 352.

Calibration preprocessor 328 may be configured to perform calibration initialization, triggering, filtering, and normalization. Calibration preprocessor 328 may include, for example, initializer 330, trigger 332, filter 334, and normalizer 336.

Initializer 330 may be configured to initialize calibration parameters, e.g., for calibration compensator 338 (e.g., for RLS compensator 340, Kalman Filter compensator 344, Neural Network compensator 342, EMA compensator 346). Initializer 330 may be configured to record initial, reference, or baseline force values, e.g., when the touchpad 300 is new or “fresh,” recently manufactured, during a first use by a particular user, etc. for use during calibration. Initial touch/click event data for some users may occur at a later time than initial touch/click event data for an original user of touchpad 300. Initializer 330 may be configured to define parameters (e.g., constants and thresholds) for the adaptive algorithms (e.g., calibration compensator(s) 338 and anomaly detection (e.g., calibration monitor 350). Initializer 330 may update a baseline force record for a user, for example, if initializer 330 detects that no such record exists for the user. Initializer 330 may update the baseline force record for a user by using initial force sensor data collected for the user. Initializer 330 will load the baseline force record for a user if the record exists. Initializer 330 may store and access initialization information in storage (e.g., TP storage device 124) for use during calibration by CM 326.

Trigger 332 can be configured to initiate calibration of force sensors by CM 326 based on satisfaction of one or more triggers, such as a trigger based on accumulation of a data for a threshold number of touch events by a user, a trigger based on elapsed time since a previous calibration, a trigger based on a new user, and/or a trigger on demand by a user. Trigger 332 may have the same or different trigger(s) to initiate calibration for each user.

As previously indicated, data collector 310 and data extractor 312 may be configured to perform data collection/generation and storage of user touch event data for access by CM 326 during calibration of force sensors. In some examples, filter 334 and/normalizer 336 may be implemented in data collector 310 or data extractor 312 to preprocess data. Force sensor data collected includes initial/reference/baseline/ground truth force sensor measurements (e.g., signals) for known forces and/or for each user for use in force sensor calibration.

Filter 334 may be configured to filter force sensor data and/or additional data used by calibration compensator 338. For example, filter 334 may apply a moving average filter to force sensor data. A moving average filter can remove high-frequency noise and sudden fluctuations in sensor data.

Normalizer 336 may be configured to normalized filtered force sensor data and/or additional data used by calibration compensator 338. For example, normalizer 336 may be configured to normalize filtered force sensor data based on one or more (e.g., predetermined) scaling parameters. A normalizer can apply scaling factors to normalize sensor data to a common value range, such as zero (0) to one (1), which may be expected by compensator algorithms. The scaling factors can be adjusted by adapter 308, for example, to calibrate sensor data for touchpad degradation.

Calibration compensator 338 can be configured to determine compensation for one or more force sensors based on the force sensor data and the reference data for each sensor, which may include average applied force, standard deviation of applied force, location of applied force, etc. Calibration can be user-specific, e.g., each user's force sensor data can be used to generate user-specific compensation parameters. Thus, compensation parameters can be user-specific, sensor-specific, and/or force-specific (e.g., to account for nonlinear response/signals generated by sensors). Calibration compensator 338 is configured to determine at least one calibration compensation parameter for each force sensor with sufficient (e.g., a threshold amount of) force sensor data for user touch events. In some examples (e.g., as shown in FIG. 3), calibration compensator 338 is configured to generate multiple compensation parameters using multiple compensators. Each sensor's response to touch events (e.g., signals providing force sensor data) can be calibrated based on device reference data (e.g., baseline force data for response to known forces by a new device) and user-specific force data for touch events. One or more compensation parameters can be determined for use in determining sensor calibration. For example, calibration can be determined by fusing together (e.g., calculating a weighted average of) compensation parameters determined by multiple compensation algorithms, such as Recursive Least Squares (RLS), Kalman Filter, a neural network (NN), and/or an Exponential Moving Average (EMA).

RLS compensator 340 can be used to estimate an RLS compensation parameter that maps normalized applied force (e.g., pressure) data from touch events to a desired output (e.g., baseline reference force signals). An existing RLS compensation parameter can be updated using the latest normalized data generated by normalizer 336. For example, at each time step (e.g., touchpad sensor sample data frame), the estimated RLS compensation parameter can be updated by weighting more recent data more heavily, which may support a rapid response to hardware drift of pressure sensors.

Kalman filter compensator 344 can be used to estimate a Kalman compensation parameter in a noisy environment. Prior knowledge and more recent force sensor data are integrated to derive an (e.g., optimal) estimate of a Kalman compensation parameter.

NN compensator 342 can be used to estimate an NN compensation parameter based on a model of a nonlinear force sensor with a nonlinear relationship between applied force and signal output by the force sensor. NN compensator 342 can be trained by calibration trainer 352. NN compensator 342 can be continuously trained and updated with incoming sensor data and the baseline reference force as a ground truth. An NN compensation parameter may be generated by feeding the most resent set of normalized force sensor data into the neural network and updating weights using the error between the predicted force sensor values and ground truth (baseline) force sensor values.

EMA compensator 346 can be used to estimate a compensation parameter that smooths out short term fluctuations while following long term trends of sensor responses. The EMA compensator can update the EMA of the existing calibration (e.g., calibration parameter) by combining a fraction of the new estimated EMA compensation parameter with the existing or previous EMA compensation parameter.

The compensation algorithm(s) can be embedded in touchpad firmware, e.g., running in real-time. The algorithms can be configured to be computationally efficient and compatible with TP TC 122 and sensor specifications. In some examples, the compensation algorithm(s) can be implemented by the OS 130 allowing user awareness, compensation and calibration computations, and storage by the host. The calibration could be transmitted from the host to the TP TC 122 (e.g., firmware) using a protocol between the OS 130 and TP TC 122.

Calibration determiner 348 can be configured to determine a (e.g., final) calibration for each force sensor based on the one or more compensation parameters generated by calibration compensator 338, e.g., in view of current and past calibrations of each force sensor. For example, calibration determiner 348 can be configured to merge multiple compensation parameters for a force sensor into a final calibration for the force sensor based on a weighted average of the compensation parameters. Calibration determiner 348 can use a fusion algorithm that assigns weights to each compensation parameter according to reliability, e.g., to ensure robust overall calibration of each sensor. Calibration determiner 348 can determine whether to use compensation parameters, for example, based on one or more thresholds. For example, calibration determiner 348 may determine to not use one or more compensation parameters if the compensation parameter is to high or too low, e.g., based on a determination that a parameter that is too high or too low is an anomaly or error in the process. Weights applied to compensation parameters may vary, for example, based on the amount of data behind the compensation parameter. For example, a compensation parameter based on insufficient amount of touch event data may be discounted with a lower weight.

As previously indicated, adapter 308 may be configured to implement (e.g., apply) the (e.g., final) calibration determined by calibration determiner 348. The calibration may be user-specific, sensor-specific, and/or force-specific. For example, adapter 308 may apply the (e.g., user-specific, sensor-specific, and/or force-specific) calibration to force sensor data (e.g., signals) collected by data collector 310 for touch events. Adapter 308 may replace a previous calibration with a new calibration determined by calibration determiner 348.

Calibration monitor 350 is configured to perform calibration monitoring, error detection (e.g., anomaly detection), and remediation (e.g., correction or abortion). Calibration monitor 350 can support reliable performance of force sensors by detecting unusual behavior or failures in the calibration process. Calibration monitor 350 may be configured to confirm that the calibrated force sensor signals align with the baseline/reference force sensor signals (e.g., within a margin of error threshold of allowable difference). Calibration monitor 350 can be configured to (e.g., continuously) monitor the residual error between the desired output of force sensors and the actual performance of force sensors. Calibration monitor 350 can be configured to compute statistical measures (e.g., standard deviation) to establish normal error bounds. Calibration monitor 350 can be configured to flag an anomaly and initiate corrective actions (e.g., parameter reset or alert issuance), for example, if an error exceeds one or more (pre)defined thresholds. Early detection of anomalies may prevent prolonged inaccuracies and support timely interventions. If the residual error is too high (e.g., exceeds a threshold), calibration monitor 350 may be configured to take remedial action, for example, by correcting/adjusting calibration, discarding current calibration and resetting calibration to a previous setting, triggering recalibration, etc. Calibration monitor 350 may be configured to reject a calibration that varies too significantly (e.g., beyond a threshold) compared to the previous calibration, e.g., based on a determination that a new calibration in excess of a threshold is an anomaly indicating an error in the process.

Calibration trainer 352 can be configured to train NN compensator 342 to maintain calibration of nonlinear sensors. Calibration trainer 322 may be configured to train NN compensator 342 using training data comprising labeled reference and current force sensor datasets and compensation parameters to maintain calibration. A training process may split a dataset into training and validation sets, e.g., to train the NN on the training set and validate performance of the trained NN on the validation set. The labeled dataset may be created based on empirical examples collected during actual or simulated use of computing device 100 or a similar computing device. Calibration trainer may implement supervised learning to train NN compensator 342. Calibration trainer 352 may perform hyperparameter tuning, e.g., to optimize the NN's hyperparameters to improve accuracy. Further description of the training applicable to NN compensator 342 by calibration trainer 352 is provided with respect to ML model 728 of FIG. 7.

In an example scenario, a laptop touchpad begins exhibiting inaccuracies due to gradual sensor wear and environmental variations. Data Collection is performed by (e.g., continuously) gathering pressure data during clicking events, segregating/labeling data for different users. A baseline reference is used to guide recalibration. Adaptive Calibration uses the RLS algorithm to rapidly update/adjust calibration parameters in response to hardware drift. Adaptive calibration uses the Kalman Filter to refine the adjustments despite measurement noise. Adaptive calibration uses the neural network model of the sensors to capture nonlinearities in calibration. Adaptive calibration uses EMA to smooth short-term fluctuations. The compensation parameters are used to determine calibration parameter adjustment. The outputs of the compensation algorithms are fused together (e.g., by weighted average) to update the calibration parameter applied to the touchpad's sensor output (e.g., by adjusting the normalization scaling factor(s)) applied to each. System monitoring is performed to check performance of the calibrated sensors. Deviation beyond acceptable (e.g., threshold) limits is flagged, which may lead to corrective actions. User awareness may be used to segregate/label user data for user-specific calibration of force sensors. If multiple users are encountered, the system maintains distinct calibration data per user based on system recognition. An integrated approach to automated dynamic calibration ensures that the touchpad remains accurate and responsive, e.g., without manual recalibration and associated downtime, despite hardware degradation over time.

In an example of sensor signals changing over time for a user's touch events, a set or window series of touch events (e.g., 100 events at different times) may show (e.g., without calibration) the user applies an average of 160 grams force (e.g., sometimes 140, sometimes 180, but average is 160). Over time, another set of touch events shows (e.g., based on uncalibrated sensor signals) that the user applies an average of 170 grams, e.g., due to hardware change in compressive material. Compensation algorithms can generate compensation parameters (e.g., multiplication factors, such as adjustment of normalization scaling factors) to calibrate the sensors independent of other sensors or wholly or partially dependent on other sensors.

Calibration may determine the average applied force in a set of user events and calibrate based on the difference (e.g., drift) compared to prior average applied force for previous sets of user events. For example, the sensor(s) signal(s) in response to user applied force may be calibrated to show an average of 160 grams consistent with user's historical applied force. The calibration (e.g., multiplication value, such as normalization scaling factor) may be nonlinear, e.g., given nonlinearity of sensor signals relative to applied force. Different forces may need different compensation, which means the compensation and calibration parameters determined may be nonlinear. A ratio may be applied to a compensation/calibration parameter depending on the applied force, resulting in application of a different compensation/calibration parameter at different levels of force, e.g., different calibration parameter at 200 grams of force compared to the calibration parameter applied to 120 grams of force.

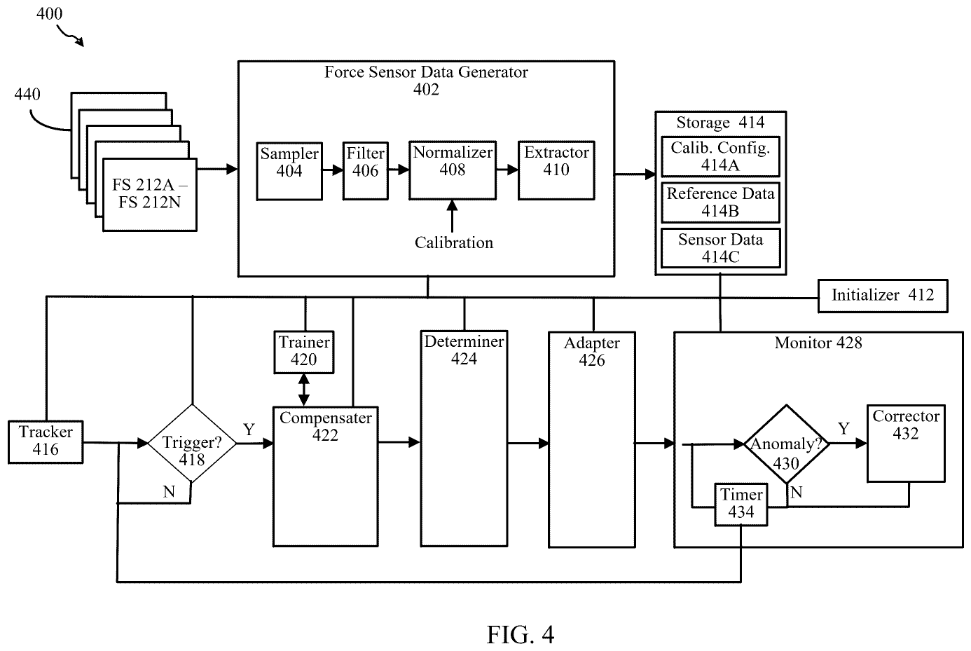

FIG. 4 shows a block diagram of a calibration manager 400 illustrating an example of operational flow and interaction to provide adaptive calibration of a haptic touchpad, in accordance with an embodiment. The example shown in FIG. 4 presents an example of interaction between modules/components shown in FIG. 3. As shown in FIG. 4, CM 400 comprises a force sensor array 440, a force sensor data generator 402, a storage 412, a tracker 414, a trigger 416, a trainer 418, a compensator 422, a determiner 424, an adapter 426, and a monitor 428. Force sensor data generator 402 includes a sampler 404, a filter 406, a normalizer 408, and an extractor 410. Monitor 428 includes a corrector 432 and a timer 434. These components of calibration manager 400 are described in further detail as follows.

Force sensors FS 212A-FS 212N are an example of force sensor array 120B in FIG. 1. Force sensors FS 212A-FS 212N include one or more force sensors (e.g., pressure sensors). For example, force sensors FS 212A-FS 212N may include six force sensors FS 212A-FS6. Force sensors FS 212A-FS 212N generate force sensor signals representative of the force applied by a user (e.g., user 140) when the user makes contact with a touchpad (e.g., by finger, palm, instrument) during a touch event. The force signals are sampled and processed by force sensor data generator 402.

Force sensor data generator 402 generates force sensor-related data (e.g., force sensor datasets) used by compensator 422. Force sensor data generator 402 provides data collection, sampling, signal processing, and data extraction/generation. Force sensor data generator 402 combines, for example, data collector 310, calibration preprocessor 328, and data extractor 312 in FIG. 3. Force sensor data generator 402 stores reference data 414B and sensor data 414C in storage 414. Force sensor data generator 402 includes sampler 404, filter 406, normalizer 408, and extractor 410.

Sampler 404 samples force sensor signals generated by FS 212A-FS 212N in response to touch events. Sampler 404 may sample force sensors FS 212A-FS 212N periodically, such as 100 times per second (e.g., every 10 msec).

Filter 406 filters force sensor data (e.g., reference data 412B and sensor data 412C) used by compensator 422. For example, filter 406 applies a moving average filter to force sensor data stored as reference data 412B and sensor data 412C. Filter 406 is an example of filter 334 in FIG. 3.

Normalizer 408 is an example of normalizer 336 in FIG. 3. Normalizer 408 may be configured to normalize filtered force sensor data used by compensator 422. For example, normalizer 408 can normalize filtered force sensor data based on one or more (e.g., predetermined) scaling parameters, which may be nonlinear based on nonlinear sensor signals, e.g., relative to applied force.

Extractor 410 generates additional data/features utilized by compensator 422 by further processing (e.g., performing calculations on) collected, filtered, and normalized data to generate other force sensor-related data. For example, extractor 410 may determine the applied force represented by the force sensor data, e.g., based on a mapping or calculation.

Force sensor data generator 402 samples, processes, and stores a series of touch event datasets as reference data 414B or sensor data 414C in storage 412. A determination whether to store filtered, normalized sensor data (e.g., and any generated data) as reference data 414B or sensor data 414C may be determined, for example, by calibration configuration 414A, and/or initializer 412, which may indicate whether the computing device is new and needs to collect reference data 414B or has already collected reference data 414B. Tracker 416 may provide information to initializer 412, which may determine whether baseline reference data generator 402 should store data as reference data 414B or sensor data 414C. For example, force sensor data generator 402 can be configured (e.g., by calibration configuration 414A and/or initializer 412) to record initial (e.g., reference, baseline) force sensor signals when the touchpad is new or “fresh,” recently manufactured, during a first use by the current user, etc.

Storage 414 stores, e.g., among other touch event data, calibration configuration 414A, reference data 414B and sensor data 414C. Storage 414 is an example of TP storage device 124 in FIG. 1. Storage 414 can be configured to store separate sets of data for each user, for example, to support user-specific calibration of force sensor data.

Calibration configuration 414A includes configurations for components of calibration manager 400. The configurations in calibration configuration 414A may be based on calibration manager 400 and hardware, such as the touchpad, and computing device.

Reference data 414B includes baseline reference force signals (e.g., and any additional extracted data) initially generated by FS 1-N for known applied forces and/or for a user's initial touch events.

Sensor data 414C includes sensor data generated by force sensors FS 212A-FS 212N for sensor events and any additional data extracted by extractor 410. Sensor data 410 indicates the most recent set of force signals generated by FS 212A-FS 212N in response to the most recent set of touch events by a user. Sensor data 414C may be wholly or partially replaced following calibration, for example, to store subsequent sensor data for future calibration.

Initializer 412 initializes each component of calibration manager 400 with calibration parameters in calibration configuration 414A. For example, initializer can be configured to initialize each compensator in calibration compensator 422 (e.g., RLS compensator, Kalman Filter compensator, Neural Network compensator, and/or EMA compensator). In some examples, initializer 412 determines whether to record or update a baseline force record for the current user, for example, if initializer 412 detects that no such record exists for the current user. Initializer 412 can be configured to receive an indication of the current user from tracker 416 to set a data storage mode for force sensor data generator 402 (e.g., reference data mode or touch event data mode). Initializer 412 can be configured to indicate to force sensor data generator 402 whether to store force data as reference data 414B or sensor data 414C for the current user. Initializer 412 can be configured to determine whether to load the baseline force record (e.g., reference data 414B) from storage 414 for the current user, e.g., if the record exists. Initializer 412 can be configured to (e.g., also) define settings and/or parameters (e.g., constants and thresholds) for components (e.g., force sensor data generator 402, trigger 418, compensator 422, determiner 424, and monitor 428), for example, based on calibration configuration 414A). Initializer 412 is an example of initializer 330 in FIG. 3.

Tracker 416 monitors and reports the current user of the computing device. Tracker 414 identifies the active user, for example, based on an indication by the operating system (e.g., OS 130). For example, tracker 416 provides a notification of the current user to trigger 418, e.g., to determine whether calibration is triggered for the current user. Tracker 416 can provide a notification of the current user to force sensor data generator 402 and/or initializer 412, for example, in support of a determination whether to store force sensor data (e.g., and additional data) as reference data 414B or sensor data 414C. Tracker 416 is an example of tracker 324 in FIG. 3.

Trigger 418 determines whether one or more triggers are satisfied to calibrate force sensors for the current user. Trigger 418 may include one or more triggers, such as a trigger based on the number of touch events represented by force sensor data 414C compared to a threshold number of touch events by the user, a trigger based on elapsed time since a previous calibration of force sensors for the user, a trigger based on the current user being a new user, and/or a trigger based on demand by the current user. Trigger 418 loops until calibration is triggered for the current user. When calibration is triggered, the calibration process begins with initializer 412. Trigger 418 is an example of trigger 332 in FIG. 3.

Trainer 420 trains a machine learning model (e.g., neural network compensator) in compensator 422. For example, trainer 420 trains the NN compensator in compensator 422 to model each nonlinear force sensor FS 1-N and to maintain calibration thereof by nonlinear compensation parameters applied to signals generated by force sensors FS 1-N. Trainer 420 is an example of calibration trainer 352 in FIG. 3.

Compensator 422 determines compensation for force sensors FS 212A-FS 212N based on the force sensor data 410 and the reference data 408 for each force sensor FS 212A-FS 212N. Compensator 422 determines one or more calibration compensation parameters (e.g., based on calibration configuration 414A or TP configuration 138) for each force sensor FS 212A-FS 212N with sufficient (e.g., a threshold amount of) force sensor data for user touch events. For example, compensator 422 determines compensation parameters using Recursive Least Squares (RLS), a Kalman Filter, a neural network (NN), and/or an Exponential Moving Average (EMA). Compensator 422 is an example of calibration compensator 338 in FIG. 3.

Determiner 424 determines a (e.g., force-sensitive nonlinear) calibration for each sensor by fusing together (e.g., calculating a weighted average of) compensation parameters RLS compensation parameter, Kalman compensation parameter, NN compensation parameter, and EMA compensation parameter. For example, determiner 424 determines a (e.g., final) calibration for each force sensor FS 212A-FS 212N based on a weighted average of the RLS compensation parameter, Kalman compensation parameter, NN compensation parameter, and EMA compensation parameter, e.g., in view of current and past calibrations of each force sensor FS 212A-FS 212N. The weights applied to each compensation parameter can be set by initializer 410 based on a configuration (e.g., calibration configuration 414A or TP configuration 138). The calibration determined by determiner 424 may be user-specific, sensor-specific, and/or force-specific. Determiner 424 is an example of calibration determiner 348 in FIG. 3.

Adapter 426 implements (e.g., applies) the (e.g., final) calibration determined by determiner 424. For example, adapter 426 applies the (e.g., user-specific, sensor-specific, and/or force-specific) calibration(s) to force sensor data (e.g., signals) generated by force sensors FS 212A-FS 212N collected by force sensor data generator 402 for touch events. Adapter 426 may replace a previous calibration with a new calibration determined by determiner 424. Calibration may be applied, for example, by adjusting one or more scaling parameters applied by normalizer 408 to filtered force sensor data. Adapter 426 is an example of adapter 308 in FIG. 3.

Monitor 428 is configured to perform calibration monitoring, error detection (e.g., anomaly detection), and remediation (e.g., correction or abortion). Monitor 428 includes, for example, anomaly detector 430, corrector 432, and timer 434. Anomaly detector 430 determines whether the calibrated force sensor signals align with the baseline/reference force sensor signals (e.g., within a margin of error threshold of allowable difference set by initializer 410). For example, anomaly detector 430 monitors the residual error between the desired output of force sensors FS 212A-FS 212N and the actual performance of force sensors FS 212A-FS 212N. Monitor 428 computes statistical measures (e.g., standard deviation) to establish normal error bounds for anomaly detector 430. Corrector 432 initiates corrective actions (e.g., parameter reset or alert issuance) in response to a detected error/anomaly. For example, remedial action taken by corrector 432 may include correcting/adjusting calibration, discarding current calibration and resetting calibration to a previous setting, triggering recalibration, etc. The anomaly detector 430 (e.g., and corrector 432 if needed) may loop for a period of time or until the occurrence of an event, such as a trigger to recalibrate force sensors, upon which the calibration begins anew with a new set of force sensor data. For example, timer 434 may be configured with a fixed or variable time for monitor 428 to monitor the performance of calibrated force sensors FS 212A-FS 212N. Monitor 428 is an example of calibration monitor 350 in FIG. 3.

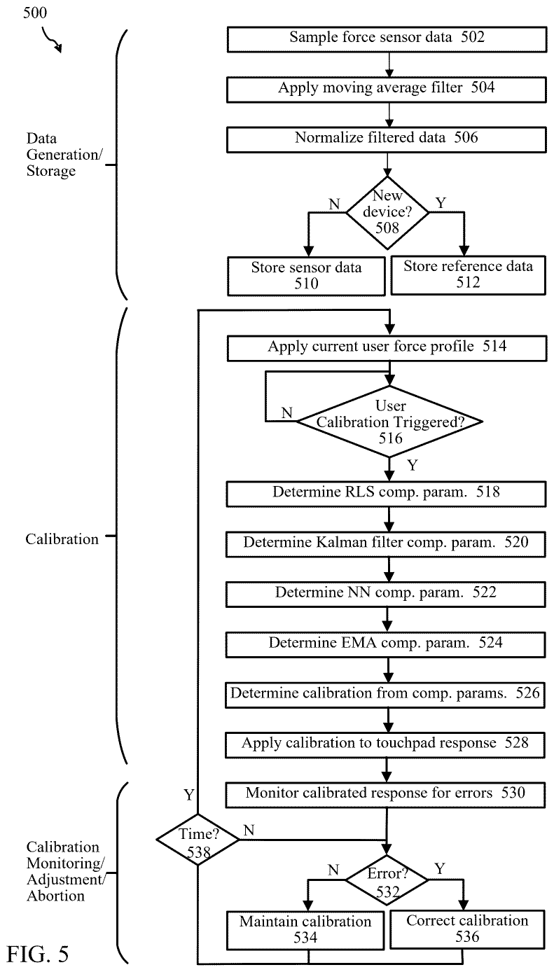

Embodiments disclosed herein may operate in various ways. For instance, FIG. 5 shows a flowchart for an example process for providing adaptive calibration of a haptic touchpad, in accordance with an embodiment. Embodiments disclosed herein and other embodiments may operate in accordance with examples shown in FIGS. 1-4. Example flowchart 500 shows an example method of providing adaptive calibration of a haptic touchpad executed by touchpad assembly 120 (e.g., touch sensor array 120A, force sensor array 120B), TP TC 122, TM 136/302, CM 160/326/400, etc. Flowchart 500 comprises steps 502-538. However, other embodiments may operate according to other methods, such as described with respect to FIG. 5. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 5. FIG. 5 is simply one of many possible embodiments. Embodiments may implement fewer, more or different steps.

As shown in FIG. 5, steps 502-512 illustrate force data generation and storage, steps 514-530 illustrate calibration, and steps 532-538 illustrate calibration monitoring. Steps 502-512 can be configured to run continuously to collect and store force sensor data for reference or for touch events by a current user of a computing device with the haptic touchpad. Note that generation/extraction of additional data based on force sensor data is not shown, but may be included in various implementations. Steps 514-536 illustrate calibration of force sensors based on force data. Steps 514-536 can be configured to run in a loop for a current user of a computing device with the haptic touchpad. Steps 514-536 use the data generated in steps 502-512 to determine calibration of force sensors for the current user.

In step 502, force sensor data is sampled. For example, as shown in FIGS. 1-4, data collector 310 or sampler 404 sample sensors FS 212A-FS 212N for force sensor data generated in response to user touch events.

In step 504, a moving average filter is applied to sensor data. For example, as shown in FIGS. 1-4, filter 334/406 applies a moving average filter to sensor data sampled in step 502 In step 506, the filtered data is normalized. For example, as shown in FIGS. 1-4, normalizer 336/408 normalizes the filtered sensor data. Normalizer 408 may implement current calibration (e.g., by calibrated scaling factors), for example, depending on whether calibration has previously occurred and whether calibration is applied/deployed by the calibration adapter 308/426.

In step 508, a determination is made whether the computing device is new. The determination can be used to determine the data collection mode (e.g., reference data collection mode or touch event mode). If the device is not new, force sensor data is stored as sensor data in step 510. If the device is new, force sensor data is stored as reference data in step 512. For example, as shown in FIGS. 1-4, initializer 330/412 or force sensor data generator 402 may be configured to determine whether the computing device is new (e.g., based on touchpad configuration 138 or calibration configuration 414A).

In step 510, force sensor data is stored as sensor data based on a determination that the device is not new, e.g., indicating reference data already exists. For example, as shown in FIGS. 1-4, data collector 310 and data extractor 312 or force sensor data generator 402 store force sensor data as sensor data 414C.

In step 512, force sensor data is stored as reference data based on a determination that the device is new. For example, as shown in FIGS. 1-4, data collector 310 and data extractor 312 or force sensor data generator 402 store force sensor data as reference data 414B.

The data collected in steps 502-512 can be used to calibrate force sensors in steps 514-536, which represents a force sensor calibration loop.

In step 514, the user force profile is applied for the current user. For example, as shown in FIGS. 1-4, calibration manager 326, initializer 330/412, and/or tracker 324/416 detect the current user and apply a user force profile for the current user, e.g., based on calibration configuration 414A.

At step 516, a determination is made whether calibration has been triggered for the current user. If there is a trigger, the calibration procedure begins at step 518. Otherwise, calibration is not performed until one or more triggers occur. For example, as shown in FIGS. 1-4, trigger 332/418 in CM 160/326/400 can be configured to initiate calibration of force sensors based on satisfaction of one or more triggers, such as a trigger based on accumulation of a data for a threshold number of touch events by the user, a trigger based on elapsed time since a previous calibration for the user, a trigger based on the current user being a new user, and/or a trigger on demand by the user.

In step 518, the RLS compensation parameter is determined. For example, as shown in FIGS. 1-4, RLS compensator 340 in calibration compensator 338/422 can be used to estimate an RLS compensation parameter that maps normalized applied force (e.g., pressure) data from touch events to a desired output (e.g., baseline reference force signals). An existing RLS compensation parameter can be updated using the latest normalized data generated by normalizer 336. For example, at each time step (e.g., touchpad sensor sample data frame), the estimated RLS compensation parameter can be updated by weighting more recent data more heavily, which may support a rapid response to hardware drift of pressure sensors.

In step 520, the Kalman filter compensation parameter is determined. For example, as shown in FIGS. 1-4, Kalman filter compensator 344 in calibration compensator 338/422 can be used to estimate a Kalman compensation parameter in a noisy environment. Prior knowledge and more recent force sensor data are integrated to derive an (e.g., optimal) estimate of a Kalman compensation parameter.

In step 522, the NN compensation parameter is determined. For example, as shown in FIGS. 1-4, NN compensator 342 in calibration compensator 338/422 can be used to estimate an NN compensation parameter based on a model of a nonlinear force sensor with a nonlinear relationship between applied force and signal output by the force sensor. NN compensator 342 can be trained by calibration trainer 352. NN compensator 342 can be continuously trained and updated with incoming sensor data and the baseline reference force as a ground truth. An NN compensation parameter may be generated by feeding the most resent set of normalized force sensor data 414C into the neural network and updating weights using the error between the predicted force sensor values and ground truth (baseline) force sensor values (e.g., as may be determined by monitor 350/428).

In step 524, the EMA compensation parameter is determined. For example, as shown in FIGS. 1-4, EMA compensator 346 in calibration compensator 338/422 can be used to estimate a compensation parameter that smooths out short term fluctuations while following long term trends of sensor responses. The EMA compensator 346 can update the EMA of the existing calibration (e.g., calibration parameter) by combining a fraction of the new estimated EMA compensation parameter with the existing or previous EMA compensation parameter.

In step 526, force sensor calibration is determined based on the compensation parameters. For example, as shown in FIGS. 1-4, calibration determiner 348/424 can be configured to determine a (e.g., final) calibration for each force sensor FS 212A-FS 212N based on the one or more compensation parameters generated by calibration compensator 338/422, e.g., in view of current and past calibrations of each force sensor FS 212A-FS 212N. For example, calibration determiner 348/422 can be configured to merge multiple compensation parameters for a force sensor into a final calibration for the force sensor based on a weighted average of the compensation parameters. Calibration determiner 348 can use a fusion algorithm that assigns weights to each compensation parameter according to reliability, e.g., to ensure robust overall calibration of each sensor.

In step 528, the calibration determined for each force sensor FS 212A-FS 212N is applied to the force sensors. For example, as shown in FIGS. 1-4, calibration adapter 308/426 may be configured to implement (e.g., apply) the (e.g., final) calibration determined by calibration determiner 348/422. The calibration may be user-specific, sensor-specific, and/or force-specific. For example, adapter 308/426 may apply the (e.g., user-specific, sensor-specific, and/or force-specific) calibration to force sensor data (e.g., signals) generated by force sensors FS 212A-FS 212N for touch events. Adapter 308 may replace a previous calibration with a new calibration determined by calibration determiner 348. Adapter 308/426 may apply calibration, for example, to one or more scaling factors used by normalization step 506.

In step 530, the calibrated responses of force sensors FS 212A-FS 212N are monitored for errors. For example, as shown in FIGS. 1-4, calibration monitor 350/428 can be configured to (e.g., continuously) monitor the residual error between the desired output of force sensors FS 212A-FS 212N and the actual performance of force sensors FS 212A-FS 212N.

In step 532, a determination is made whether an error exists. If there is an error, calibration may be corrected in step 536. Otherwise, calibration may be maintained, e.g., in step 534. For example, as shown in FIGS. 1-4, calibration monitor 350/428 can be configured to detect unusual behavior or failures in the calibration process. Calibration monitor 350/428 may be configured to confirm that the calibrated force sensor signals align with the baseline/reference force sensor signals (e.g., within a margin of error threshold of allowable difference). Calibration monitor 350/428 can be configured to compute statistical measures (e.g., standard deviation) to establish normal error bounds, e.g., to determine what an error is and whether an error occurred.

In step 534, calibration is maintained if a calibration error is not detected. For example, as shown in FIGS. 1-4, anomaly detector 430 may continue to loop while time remains under timer 434.

In step 536, calibration is corrected if a calibration error is detected. For example, as shown in FIGS. 1-4, corrector 432 can engage in remediation (e.g., correction or abortion) of the most recent calibration of force sensors FS 212A-FS 212N. Calibration monitor 350/428 or corrector 432 can be configured to initiate corrective actions (e.g., parameter reset or alert issuance), for example, if an error exceeds one or more (pre)defined thresholds. Early detection of anomalies may prevent prolonged inaccuracies and support timely interventions. If the residual error is too high (e.g., exceeds a threshold), calibration monitor 350/428 or corrector 432 may be configured to take remedial action, for example, by correcting/adjusting calibration, discarding current calibration and resetting calibration to a previous setting, triggering recalibration, etc.

In step 538, a determination is made whether to continue monitoring calibration. For example, as shown in FIGS. 1-4, timer 434 determines whether a calibration monitoring time period has expired to determine whether to proceed to step 532 to continue monitoring calibration or proceed to step 514 to await subsequent calibration.

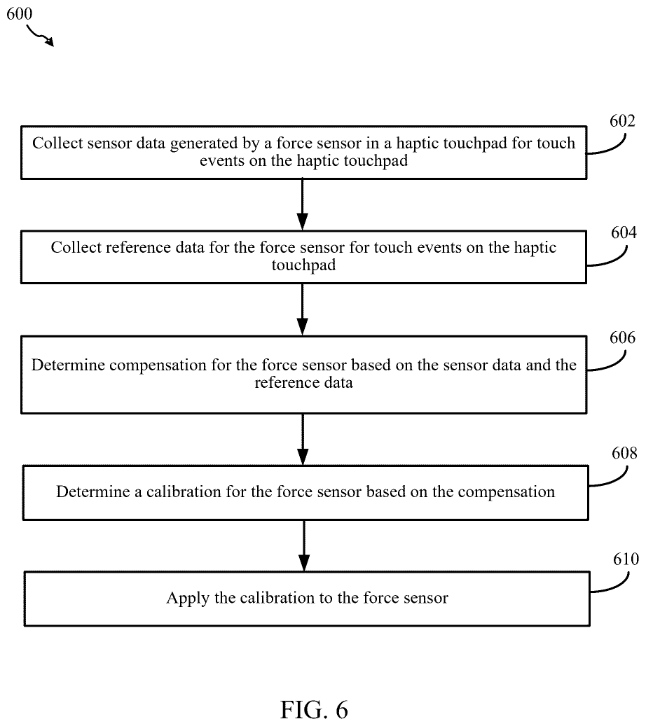

FIG. 6 shows a flowchart for an example process for providing adaptive calibration of a haptic touchpad, in accordance with an embodiment. Embodiments disclosed herein and other embodiments may operate in accordance with examples shown in FIGS. 1-5. Flowchart 600 shows an example method of providing adaptive calibration of a haptic touchpad executed by touchpad assembly 120 (e.g., touch sensor array 120A, force sensor array 120B), TP TC 122, TM 136/302, CM 160/326/400, etc. The example shown in FIG. 6 includes operations 602-610. There is no requirement that a method embodiment implement all of the steps illustrated in FIG. 6. FIG. 6 is simply one of many possible embodiments. Various embodiments may implement one or more operations shown in FIG. 6 with additional and/or alternative steps. Further structural and operational embodiments will be apparent to persons skilled in the relevant art(s) based on the following description of FIG. 6.

As shown in example flowchart 600, at step 602, sensor data generated by a force sensor in a haptic touchpad for touch events on the haptic touchpad is collected. For example, as shown in FIGS. 1-4, data collector 310, data extractor 312, and calibration preprocessor 328 or force sensor data generator 402 collects/generates force sensor-related data based on signals generated by force sensors FS 212A-FS 212N in response to touch events. As shown in FIG. 4 in step 502-510, force sensor data is sampled, filtered, normalized, and stored.

In step 604, reference data is collected for the force sensor for touch events on the haptic touchpad. For example, as shown in FIGS. 1-4, data collector 310, data extractor 312, and calibration preprocessor 328 or force sensor data generator 402 collects/generates reference force sensor-related data based on signals generated by force sensors FS 212A FS 212N, e.g., in response to known forces, such as when the computing device is new. As shown in FIG. 5 in step 502-512, reference force sensor data is sampled, filtered, normalized, and stored.

In step 606, compensation is determined for the force sensor based on the sensor data and the reference data. For example, as shown in FIGS. 1-4, calibration compensator 338/422 determines one or more compensation parameters based on the force sensor data related to touch events and the reference force sensor data.

In step 608, calibration is determined for the force sensor based on the compensation. For example, as shown in FIGS. 1-4, determiner 348/424 determines calibration based on the one or more compensation parameters.

In step 610, the calibration is applied to the force sensor. For example, as shown in FIGS. 1-4, adapter 308/426 applies the calibration to the force sensor, e.g., by adapting a one or more scaling factors of normalizer 336/408 to implement the calibration, which may be nonlinear over a range of forces applied to the force sensor.

### III. Example Computing Device Embodiments

In embodiments, one or more of TP TC 122, TM 136/302, CM 160/326/400, OS 130, application(s) 134, TP config 138, interface 304, customizer 306, adapter 308/426, data collector 310, data extractor 312/410, tracker 324/416, initializer 330, trigger 332/418, calibration preprocessor 328, filter 334/406, normalizer 336/408, calibration compensator 338/422, RLS compensator 340, NN compensator 342, Kalman filter compensator 344, EMA compensator 346, calibration determiner 348/424, calibration monitor 350/428, calibration trainer 352/420, force sensor data generator 402, sampler 404, calibration configuration 414A, reference data 414B, sensor data 414C, anomaly detector 430, corrector 432, timer 434, flowcharts 500 and 600 is/are implemented with computer program code/instructions configured to be executed in one or more processors and stored in a computer readable storage medium. Additionally or alternatively, one or more of TP TC 122, TM 136/302, CM 160/326/400, OS 130, application(s) 134, TP config 138, interface 304, customizer 306, adapter 308/426, data collector 310, data extractor 312/410, tracker 324/416, initializer 330, trigger 332/418, calibration preprocessor 328, filter 334/406, normalizer 336/408, calibration compensator 338/422, RLS compensator 340, NN compensator 342, Kalman filter compensator 344, EMA compensator 346, calibration determiner 348/424, calibration monitor 350/428, calibration trainer 352/420, force sensor data generator 402, sampler 404, calibration configuration 414A, reference data 414B, sensor data 414C, anomaly detector 430, corrector 432, timer 434, flowcharts 500 and 600 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions. In still further embodiments, one or more of TP TC 122, TM 136/302, CM 160/326/400, OS 130, application(s) 134, TP config 138, interface 304, customizer 306, adapter 308/426, data collector 310, data extractor 312/410, tracker 324/416, initializer 330, trigger 332/418, calibration preprocessor 328, filter 334/406, normalizer 336/408, calibration compensator 338/422, RLS compensator 340, NN compensator 342, Kalman filter compensator 344, EMA compensator 346, calibration determiner 348/424, calibration monitor 350/428, calibration trainer 352/420, force sensor data generator 402, sampler 404, calibration configuration 414A, anomaly detector 430, corrector 432, timer 434, flowcharts 500 and 600 are implemented in further forms of electrical circuitry, including logic gates, transistors, operational amplifiers, field programmable gate arrays (FPGAs), etc.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 7. FIG. 7 shows a block diagram of an exemplary computing environment 700 that includes a computing device 702. Computing device 702 is an example of computing device 100, which may include one or more of the components of computing device 702. In some embodiments, computing device 702 is communicatively coupled with devices (not shown in FIG. 7) external to computing environment 700 via network 704. Network 704 comprises one or more networks such as local area networks (LANs), wide area networks (WANs), enterprise networks, the Internet, etc. In examples, network 704 includes one or more wired and/or wireless portions. In some examples, network 704 additionally or alternatively includes a cellular network for cellular communications. Computing device 702 is described in detail as follows.

Computing device 702 is any of a variety of types of computing devices. Examples of computing device 702 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 702 is a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, a graphics processing unit (GPU) 742, a neural processing unit (NPU) 744, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 788. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and in a particular embodiment any combination of the components are present. In examples, components of computing device 702 are mounted to a circuit card (e.g., a motherboard) of computing device 702, integrated in a housing of computing device 702, or otherwise included in computing device 702. The components of computing device 702 are described as follows.

In embodiments, a single processor 710 (e.g., central processing unit (CPU), microcontroller, a microprocessor, signal processor, A SIC (application specific integrated circuit), and/or other physical hardware processor circuit) or multiple processors 710 are present in computing device 702 for performing such tasks as program execution, signal coding, data processing, input/output processing, power control, and/or other functions. In examples, processor 710 is a single-core or multi-core processor, and each processor core is single-threaded or multithreaded (to provide multiple threads of execution concurrently). Processor 710 is configured to execute program code stored in a computer readable medium, such as program code of operating system 712 and application programs 714 stored in storage 720. The program code is structured to cause processor 710 to perform operations, including the processes/methods disclosed herein. Operating system 712 controls the allocation and usage of the components of computing device 702 and provides support for one or more application programs 714 (also referred to as “applications” or “apps”). In examples, application programs 714 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 710 includes one or more general processors (e.g., CPUs) configured with or coupled to one or more hardware accelerators, such as one or more NPUs 744 and/or one or more GPUs 742.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) present to communicatively couple processor 710 to various other components of computing device 702, although in other embodiments, an alternative bus, further buses, and/or one or more individual signal lines is/are present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 788, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 722 includes main memory and is separate from or fabricated in a same integrated circuit as processor 710. As shown in FIG. 7, non-removable memory 722 stores firmware 718 that is present to provide low-level control of hardware. Examples of firmware 718 include BIOS (Basic Input/Output System, such as on personal computers) and boot firmware (e.g., on smart phones). In examples, removable memory 724 is inserted into a receptacle of or is otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 788 are present that are internal and/or external to a housing of computing device 702 and are or are not removable. Examples of storage device 788 include a hard disk drive, a SSD, a thumb drive (e.g., a USB (Universal Serial Bus) flash drive), or other physical storage device.

One or more programs are stored in storage 720. Such programs include operating system 712, one or more application programs 714, and other program modules and program data. Examples of such application programs include computer program logic (e.g., computer program code/instructions) for implementing one or more of TP TC 122, TM 136/302, CM 160/326/400, OS 130, application(s) 134, TP config 138, interface 304, customizer 306, adapter 308/426, data collector 310, data extractor 312/410, tracker 324/416, initializer 330, trigger 332/418, calibration preprocessor 328, filter 334/406, normalizer 336/408, calibration compensator 338/422, RLS compensator 340, NN compensator 342, Kalman filter compensator 344, EMA compensator 346, calibration determiner 348/424, calibration monitor 350/428, calibration trainer 352/420, force sensor data generator 402, sampler 404, calibration configuration 414A, reference data 414B, sensor data 414C, anomaly detector 430, corrector 432, timer 434, flowcharts 500 and 600 (and/or any individual operations/steps thereof).

Storage 720 also stores data used and/or generated by operating system 712 and application programs 714 as application data 716. Examples of application data 716 include web pages, text, images, tables, sound files, video data, and other data. In examples, application data 716 is sent to and/or received from one or more network servers or other devices via one or more wired or wireless networks. Storage 720 is used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 702 through one or more input devices 730 and receives information from computing device 702 through one or more output devices 750. Input device(s) 730 includes one or more of touch screen 732, microphone 734, camera 736, physical keyboard 738, and/or trackball 740 and output device(s) 750 includes one or more of speaker 752 and display 754. Each of input device(s) 730 and output device(s) 750 are integral to computing device 702 (e.g., built into a housing of computing device 702) or are external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 displays information, as well as operating as touch screen 732 by receiving user commands and/or other information (e.g., by touch, finger gestures, virtual keyboard, etc.) as a user interface. Any number of each type of input device(s) 730 and output device(s) 750 are present, including multiple microphones 734, multiple cameras 736, multiple speakers 752, and/or multiple displays 754.

In embodiments where GPU 742 is present, GPU 742 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 742 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 744 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 728. In an example, NPU 744 is configured for a data-driven parallel computing and is highly efficient at processing massive multimedia data such as videos and images and processing data for neural networks. NPU 744 is configured for efficient handling of A I-related tasks, such as speech recognition, background blurring in video calls, photo or video editing processes like object detection, etc.

In embodiments disclosed herein that implement ML models, NPU 744 can be utilized to execute such ML models, of which MLM 728 is an example. For instance, where applicable, MLM 728 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 744 is used to train MLM 728. To train MLM 728, training data is that includes input features (attributes) and their corresponding output labels/target values (e.g., for supervised learning) is collected. A training algorithm is a computational procedure that is used so that MLM 728 learns from the training data. Examples of training inputs for ML model training include user position, angle, gesture, time of day, location, user crypto, etc. Parameters/weights are internal settings of MLM 728 that are adjusted during training by the training algorithm to reduce a difference between predictions by MLM 728 and actual outcomes (e.g., output labels). In some examples, MLM 728 is set with initial values for the parameters/weights. A loss function measures a dissimilarity between predictions by MLM 728 and the target values, and the parameters/weights of MLM 728 are adjusted to minimize the loss function. The parameters/weights are iteratively adjusted by an optimization technique, such as gradient descent. In this manner, MLM 728 is generated through training by NPU 744 to be used to generate inferences based on received input feature sets for particular applications. MLM 728 is generated as a computer program or other type of algorithm configured to generate an output (e.g., a classification, a prediction/inference) based on received input features and is stored in the form of a file or other data structure.

In examples, such training of MLM 728 by NPU 744 is supervised or unsupervised. According to supervised learning, input objects (e.g., a vector of predictor variables) and a desired output value (e.g., a human-labeled supervisory signal) train MLM 728. The training data is processed, building a function that maps new data on expected output values. Example algorithms usable by NPU 744 to perform supervised training of MLM 728 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 728 is an LLM, MLM 728 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 728 is trained to learn patterns from unlabeled data. For instance, in embodiments where MLM 728 implements unsupervised learning techniques, MLM 728 identifies one or more classifications or clusters to which an input belongs. During a training phase of MLM 728 according to unsupervised learning, MLM 728 tries to mimic the provided training data and uses the error in its mimicked output to correct itself (i.e., correct weights and biases). In further examples, NPU 744 perform unsupervised training of MLM 728 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 744 need not necessarily be present in all M L model embodiments. In embodiments where ML models are present, any one or more of processor 710, GPU 742, and/or NPU 744 can be present to train and/or execute MLM 728.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). In examples, wireless modem 760 also or alternatively includes other radio-based modem types, such as a Bluetooth modem 764 (also referred to as a “Bluetooth device”) and/or Wi-Fi modem 762 (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and receives power from a battery internal to computing device 702, and/or from a power cord plugged into a power port of computing device 702 (e.g., a USB port, an A/C power port). LI receiver 784 is useable for location determination of computing device 702 and in examples includes a satellite navigation receiver such as a Global Positioning System (GPS) receiver and/or includes other type of location determiner configured to determine location of computing device 702 based on received information (e.g., using cell tower triangulation, etc.). Accelerometer 786, when present, is configured to determine an orientation of computing device 702.

Note that the illustrated components of computing device 702 are not required or all-inclusive, and fewer or greater numbers of components can be present as would be recognized by one skilled in the art. In examples, computing device 702 includes one or more of a gyroscope, barometer, proximity sensor, ambient light sensor, digital compass, etc. In an example, processor 710 and memory 756 are co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein is stored in storage 720 and executed by processor 710.

In some embodiments, server infrastructure 770 is present in computing environment 700 and is communicatively coupled with computing device 702 via network 704. Server infrastructure 770, when present, is a network-accessible server set (e.g., a cloud-based environment or platform). As shown in FIG. 7, server infrastructure 770 includes clusters 772. Each of clusters 772 comprises a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. In examples, any of nodes 774 is a storage node that comprises a plurality of physical storage disks, SSDs, and/or other physical storage devices that are accessible via network 704 and are configured to store data associated with the applications and services managed by nodes 774.

Each of nodes 774, as a compute node, comprises one or more server computers, server systems, and/or computing devices. For instance, a node 774 in accordance with an embodiment includes one or more of the components of computing device 702 disclosed herein. Each of nodes 774 is configured to execute one or more software applications (or “applications”) and/or services and/or manage hardware resources (e.g., processors, memory, etc.), which are utilized by users (e.g., customers) of the network-accessible server set. In examples, as shown in FIG. 7, nodes 774 includes a node 746 that includes storage 748 and/or one or more of a processor 758 (e.g., similar to processor 710, GPU 742, and/or NPU 744 of computing device 702). Storage 748 stores application programs 776 and application data 778. Processor(s) 758 operates application programs 776 which access and/or generate related application data 778. In an implementation, nodes such as node 746 of nodes 774 operate or comprise one or more virtual machines, with each virtual machine emulating a system architecture (e.g., an operating system), in an isolated manner, upon which applications such as application programs 776 are executed.

In embodiments, one or more of clusters 772 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 772 are included in a datacenter in a distributed collection of datacenters. In embodiments, exemplary computing environment 700 comprises part of a cloud-based platform.

In an embodiment, computing device 702 accesses application programs 776 for execution in any manner, such as by a client application and/or a browser at computing device 702.

In an example, for purposes of network (e.g., cloud) backup and data security, computing device 702 additionally and/or alternatively synchronizes copies of application programs 714 and/or application data 716 to be stored at network-based server infrastructure 770 as application programs 776 and/or application data 778. In examples, operating system 712 and/or application programs 714 include a file hosting service client configured to synchronize applications and/or data stored in storage 720 at network-based server infrastructure 770.

In some embodiments, on-premises servers 792 are present in computing environment 700 and are communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 can be shared by on-premises servers 792 between computing devices of the organization, including computing device 702 (when part of an organization) through a local network of the organization, and/or through further networks accessible to the organization (including the Internet). Furthermore, in examples, on-premises servers 792 serve applications such as application programs 796 to the computing devices of the organization, including computing device 702. Accordingly, in examples, on-premises servers 792 include storage 794 (which includes one or more physical storage devices such as storage disks and/or SSDs) for storage of application programs 796 and application data 798 and include a processor 790 (e.g., similar to processor 710, GPU 742, and/or NPU 744 of computing device 702) for execution of application programs 796. In some embodiments, multiple processors 790 are present for execution of application programs 796 and/or for other purposes. In further examples, computing device 702 is configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 is used to implement systems, clients, or devices, or components/subcomponents thereof, disclosed elsewhere herein. In other embodiments, a combination of computing device 702, network-based server infrastructure 770, and/or on-premises servers 792 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules, or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 714) are stored in storage 720. Such computer programs can also be received via wired interface(s) 760 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### IV. Additional Example Embodiments

Adaptive calibration of haptic touchpads is disclosed herein. Calibration compensates for touch device degradation over time to maintain like-new touch device performance. Calibration can occur during ongoing touch device detection, classification, and response to user touch events. Calibration can be adapted or customized to each user and/or each force sensor, e.g., given that users apply different forces in different areas of a touchpad and force sensor responses can be nonlinear relative to applied force. The signals generated by each force sensor in response to touch events is calibrated based on device reference data (e.g., baseline force data for response to known forces by a new device) and user-specific force data for touch events. Touch device calibration can be determined by fusing together (e.g., calculating a weighted average of) compensation parameters determined by multiple compensation algorithms, such as Recursive Least Squares (RLS), Kalman Filter, a neural network (NN), and/or an Exponential Moving Average (EMA). RLS can be used to estimate a compensation parameter to map normalized applied force to reference force signals. A Kalman filter can be used to estimate a compensation parameter in a noisy environment. A neural network can be used to estimate a compensation parameter based on a model of a nonlinear force sensor having a nonlinear relationship between applied force and signal output by the force sensor. EMA can be used to estimate a compensation parameter that smooths out short term fluctuations while following long term trends of sensor responses.

Computing systems are described herein. In an aspect, a computing device comprises a touch device (e.g., haptic touchpad) and a calibration manager configured to calibrate the haptic touchpad (e.g., in real time in response to hardware degradation). The device includes a touch sensor configured to detect contact (e.g., touch events) on the touch device. The device includes one or more force sensors configured to detect force applied during touch events. The device includes a data collector configured to collect force sensor data (e.g., indicating applied force) generated by a force sensor in the haptic touchpad for touch events on the haptic touchpad. The collector collects reference data (e.g., ground truth) for the force sensor, e.g., using known forces, such as during an initial calibration when the computing device is new. The device can include a tracker that monitors which user is using the device. The device can include a trigger to initiate calibration for each user (e.g., based on accumulated force sensor data for the user). The device can include a calibration preprocessor configured to filter and normalize the sensor data before compensation. The device includes a compensator configured to determine compensation for one or more force sensors based on the force sensor data and the reference data. The compensator can include one or more of an RLS compensator, a Kalman filter compensator, a neural network compensator, an EMA compensator, etc. The device includes a determiner configured to determine a calibration for the force sensor based on the compensation. For example, multiple compensation parameters can be merged into a final calibration based on a weighted average of the compensation parameters. The device includes an adapter configured to apply the calibration to the force sensor. The device can monitor the performance of calibrated force sensors and make corrections.

In some examples, the haptic touchpad comprises a plurality of force sensors. The compensation and calibration can be determined for and applied to each of the plurality of force sensors.

In some examples, the calibration is nonlinear (e.g., varies by force indicated by the sensor data).

In some examples, the calibration manager is triggered to calibrate the haptic touchpad when a quantity of touch events exceeds a trigger threshold.

In some examples, the compensator uses a neural network (NN) compensator to determine an NN compensation parameter. The compensation may be based at least in part on the NN compensation parameter.

In some examples, the NN compensator models a nonlinear relationship between forces applied during touch events and sensor data generated by the sensor.

In some examples, the compensator uses at least one of a recursive least squares (RLS) compensator to generate an RLS compensation parameter, a Kalman filter compensator to determine a Kalman compensation parameter, or an exponential moving average (EMA) compensator configured to generate an EMA compensation parameter. The compensation can be based on the NN compensation parameter and at least one of the RLS compensation parameter, the Kalman compensation parameter, or the EMA compensation parameter.

In some examples, the compensator comprises a plurality of compensators configured to generate a plurality of compensation parameters. The determiner determines the calibration by calculating a weighted average of the plurality of compensation parameters.

In some examples, the plurality of compensators comprises: a Recursive Least Squares (RLS) compensator configured to generate an RLS compensation parameter; a Kalman filter (KF) compensator configured to generate a KF compensation parameter; and a neural network (NN) compensator configured to generate an NN compensation parameter; and an exponential moving average (EMA) compensator configured to generate an EMA compensation parameter.

In some examples, the computing device further comprises a calibration monitor configured to monitor sensor data for a residual error between projected sensor data and actual sensor data, and to provide an indication of a detected residual error exceeding an error threshold.

In some examples, the computing device further comprises a calibration preprocessor configured to filter and normalize the sensor data before compensation. For example, a filter can apply a moving average filter to eliminate high frequency noise. A normalizer can apply one or more (e.g., nonlinear) scaling factors to the filtered sensor data.

In some examples, the computing device further comprises a tracker (e.g., a user awareness module) configured to distinguish sensor data for each of a plurality of users of the computing device (e.g., based on operating system recognition). The calibration manager can be configured to calibrate the touchpad separately for each of the plurality of users based on the sensor data associated with each user.

Methods are described herein. In some examples, a method comprises collecting sensor data generated by a force sensor in a haptic touchpad for touch events on the haptic touchpad; collecting reference data for the force sensor for touch events on the haptic touchpad using known forces; determining compensation for the force sensor based on the sensor data and the reference data; determining a calibration for the force sensor based on the compensation; and applying the calibration to the force sensor.

In some examples, the method further comprises collecting sensor data generated by a plurality of force sensors in the haptic touchpad for touch events on the haptic touchpad; collecting reference data for each of the plurality of force sensors for touch events on the haptic touchpad; determining compensation for each of the plurality of force sensors based on the sensor data and the reference data associated with each sensor; determining a calibration for each of the plurality of force sensors based on the compensation determined for each of the plurality of force sensors; and applying each of the calibrations to a respective force sensor among the plurality of force sensors.

In some examples, the determination of the compensation comprises: using a neural network (NN) to determine an NN compensation parameter, wherein the NN models a nonlinear relationship between forces applied during touch events and sensor data generated by the sensor; and determining the calibration based at least in part on the NN compensation parameter.

In some examples, the determination of the compensation comprises: using at least one of a recursive least squares (RLS) compensator to generate an RLS compensation parameter, a Kalman filter compensator to determine a Kalman compensation parameter, or an exponential moving average (EMA) compensator configured to generate an EMA compensation parameter; and determining the calibration based on the NN compensation parameter and at least one of the RLS compensation parameter, the Kalman compensation parameter, or the EMA compensation parameter.

In some examples, the determination of the compensation comprises: using a plurality of compensators to generate a plurality of compensation parameters: and determining the calibration based on a weighted average of the plurality of compensation parameters.

In some examples, the plurality of compensators comprise a Recursive Least Squares (RLS) compensator configured to generate an RLS compensation parameter; a Kalman filter (KF) compensator configured to generate a KF compensation parameter; and a neural network (NN) compensator configured to generate an NN compensation parameter; and an exponential moving average (EMA) compensator configured to generate an EMA compensation parameter.

In some examples, the method further comprises monitoring sensor data for a residual error between projected sensor data and actual sensor data; and generating an indication of a detected residual error exceeding an error threshold.

In some examples, the method further comprises maintaining sensor data for each of a plurality of users of the computing device; and calibrating the touchpad separately for each of the plurality of users based on the sensor data associated with each user.

A computer-readable storage medium is described herein. The computer-readable storage medium has computer program logic recorded thereon that, executed by a processor circuit, causes the processor circuit to perform a method. The method may comprise, for example, any combination of operations described herein.

For example, a method may comprise collecting sensor data generated by a force sensor in a haptic touchpad for touch events on the haptic touchpad; collecting reference data for the force sensor for touch events on the haptic touchpad using known forces; determining compensation for the force sensor based on the sensor data and the reference data; determining a calibration for the force sensor based on the compensation; and applying the calibration to the force sensor.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A computing device comprising a haptic touchpad and a calibration manager configured to calibrate the haptic touchpad, the computing device comprising:
a collector configured to collect sensor data generated by each of a plurality of force sensors included in a force sensor array distributed across an area within the haptic touchpad for touch events on the haptic touchpad, wherein the collector collects reference data for each of the plurality of the force sensors;
a compensator configured to determine compensation for each of the plurality of force sensors based on determined haptic touchpad degradation associated with each of the plurality of force sensors using the sensor data and the reference data for a corresponding one of the plurality of force sensors;
a determiner configured to determine a calibration for each of the plurality of the force sensors based on the determined compensation; and
an adapter configured to apply the calibration to each of the plurality of the force sensors to provide the haptic touchpad calibration for individual regions across the area of the haptic touchpad.

2. The computing device of claim 1, wherein the determined haptic touchpad degradation includes degradation of at least one of the plurality of force sensors and/or degradation of haptic touchpad hardware.

3. The computing device of claim 1, wherein the calibration is nonlinear.

4. The computing device of claim 1, wherein the calibration manager is triggered to calibrate the haptic touchpad when a quantity of touch events exceeds a trigger threshold.

5. The computing device of claim 1, wherein the compensator uses a neural network (NN) compensator to determine an NN compensation parameter for each of the plurality of force sensors, wherein the compensation for each of the plurality of force sensors is based at least in part on the NN compensation parameter for a corresponding one of the plurality of force sensors.

6. The computing device of claim 5, wherein the NN compensator models nonlinear relationships between forces applied during touch events and sensor data generated by each of the plurality of force sensors.

7. (canceled)

8. (canceled)

9. The computing device of claim 21, wherein the plurality of compensators comprises:
a recursive least squares (RLS) compensator configured to generate an RLS compensation parameter;
a Kalman filter (KF) compensator configured to generate a KF compensation parameter;
and a neural network (NN) compensator configured to generate an NN compensation parameter; and
an exponential moving average (EMA) compensator configured to generate an EMA compensation parameter.

10. The computing device of claim 1, the computing device further comprising:
a calibration monitor configured to monitor the sensor data for a residual error between projected sensor data and actual sensor data, and to provide an indication of a detected residual error exceeding an error threshold.

11. The computing device of claim 1, the computing device further comprising:
a calibration preprocessor configured to filter and normalize the sensor data before compensation.

12. The computing device of claim 1, the computing device further comprising:
a tracker configured to distinguish the sensor data for each of a plurality of users of the computing device,
wherein the calibration manager is configured to calibrate the touchpad separately for each of the plurality of users based on the sensor data associated with each user.

13. A method comprising:
collecting sensor data generated by each of a plurality of force sensors included in a force sensor array distributed across an area within a haptic touchpad for touch events on the haptic touchpad;
collecting reference data for each of the plurality of force sensors for touch events on the haptic touchpad using known forces;
determining haptic touchpad degradation associated with each of the plurality of the force sensors using the sensor data and the reference data for a corresponding one of the plurality of force sensors;
determining compensation for each of the plurality of the force sensors based on the determined haptic touchpad degradation;
for each of the plurality of the force sensors determining a calibration based on the compensation determined for the force sensor; and
applying the calibration determined for each of the plurality of the force sensors to the force sensors to provide the calibration of the haptic touchpad for individual regions across the area of the haptic touchpad.

14. (canceled)

15. The method of claim 13, wherein the determination of the compensation comprises:
using a neural network (NN) to determine a plurality of NN compensation parameters. each of which correspond to one of the plurality of force sensors, wherein the NN models a nonlinear relationship between forces applied during touch events and force sensor data generated by a corresponding force sensor; and
determining the calibration for each of the plurality of the force sensors based at least in part on the corresponding NN compensation parameter.

16. The method of claim 15, wherein the determination of the compensation comprises:
using at least one of a recursive least squares (RLS) compensator to generate RLS compensation parameters, a Kalman filter compensator to determine Kalman compensation parameters, or an exponential moving average (EMA) compensator configured to generate EMA compensation parameters; and
determining the calibration based on the plurality of NN compensation parameters and at least one of the RLS compensation parameters, the Kalman compensation parameters, or the EMA compensation parameters.

17. The method of claim 15, wherein the determination of the compensation comprises:
using a plurality of compensators to generate the plurality of NN compensation parameters: and
determining the calibration based on a weighted average of the plurality of NN compensation parameters.

18. The method of claim 17, wherein the plurality of compensators comprises:
a Recursive Least Squares (RLS) compensator configured to generate an RLS compensation parameter;
a Kalman filter (KF) compensator configured to generate a KF compensation parameter; and
a neural network (NN) compensator configured to generate an NN compensation parameter; and
an exponential moving average (EMA) compensator configured to generate an EMA compensation parameter.

19. The method of claim 13, further comprising:
monitoring the sensor data for a residual error between projected sensor data and actual sensor data; and
generating an indication of a detected residual error exceeding an error threshold.

20. The method of claim 13, further comprising:
maintaining sensor data for each of a plurality of users of a computing device including the haptic touchpad; and
calibrating the touchpad separately for each of the plurality of users based on the sensor data associated with each user.

21. A computing device comprising a haptic touchpad and a calibration manager configured to calibrate the haptic touchpad, the computing device comprising:
a collector configured to collect sensor data generated by a force sensor in the haptic touchpad for touch events on the haptic touchpad, wherein the collector collects reference data for the force sensor;
a compensator configured to determine compensation for the force sensor based on the sensor data and the reference data, the compensator comprising a plurality of compensators configured to generate a plurality of compensation parameters;
a determiner configured to determine a calibration for the force sensor based on the compensation, wherein the determiner determines the calibration by calculating a weighted average of the plurality of compensation parameters; and
an adapter configured to apply the calibration to the force sensor.

22. A computing device comprising a haptic touchpad and a calibration manager configured to calibrate the haptic touchpad, the computing device comprising:
a collector configured to collect sensor data generated by a force sensor in the haptic touchpad for touch events on the haptic touchpad, wherein the collector collects reference data for the force sensor;
a compensator configured to use a neural network (NN) compensator to determine an NN compensation parameter and the compensator configured to use at least one of: a recursive least squares (RLS) compensator to generate an RLS compensation parameter, a Kalman filter compensator to determine a Kalman compensation parameter, or an exponential moving average (EMA) compensator configured to generate an EMA compensation parameter, wherein the compensator is configured to determine compensation based on the sensor data, the reference data, the NN compensation parameter and at least one of the RLS compensation parameter, the Kalman compensation parameter, or the EMA compensation parameter;
a determiner configured to determine a calibration for the force sensor based on the compensation; and
an adapter configured to apply the calibration to the force sensor.

23. The method of claim 13, wherein:
the determined haptic touchpad degradation includes at least one of:
degradation of at least one of the plurality of force sensors; or
a degradation of haptic touchpad hardware.
